(19) United States
(12) Patent Application Publication
(10) Pub. No.: US 2025/0287247 A1
(43) Pub. Date: Sep. 11, 2025

(54) AUGMENTED INFORMATION EXCHANGE IN WIRELESS NETWORK

(71) Applicant: Cisco Technology, Inc., San Jose, CA (US)

(72) Inventors: Jerome Henry, Pittsboro, NC (US); Javier Contreras, Barcelona (ES); Binita Gupta, San Diego, CA (US); Brian Hart, Sunnyvale, CA (US)

(21) Appl. No.: 19/071,634

(22) Filed: Mar. 5, 2025

Related U.S. Application Data
(60) Provisional application No. 63/563,870, filed on Mar. 11, 2024.

(51) Int. Cl. H04W 24/10; H04W 24/08

(52) U.S. Cl. CPC H04W 24/10; H04W 24/08

(57) ABSTRACT

Devices and methods for augmented information exchange in wireless network are provided. A network device includes one or more processors and a memory communicatively coupled to the one or more processors. The memory includes a communication logic that is configured to generate a diagnostic request frame comprising one or more subelement fields corresponding to at least one of: a device model, an Operating System (OS) version, a vendor OS version, a service provider version, a power source, or a previous session issue. The communication logic is configured to transmit the diagnostic request frame to a wireless device. The communication logic is configured to receive, from the wireless device, in response to the diagnostic request frame, a diagnostic report frame comprising a set of attributes associated with the one or more subelement fields.

### CROSS-REFERENCE TO RELATED APPLICATIONS

This application claims priority to and benefit of U.S. Provisional Application No. 63/563,870, filed Mar. 11, 2024, the entirety of which is incorporated herein by reference.

### FIELD

The present disclosure relates to wireless communication. More particularly, the present disclosure relates to an augmented information exchange in wireless networks.

### BACKGROUND

Wi-Fi, or wireless fidelity, is a ubiquitous technology that enables wireless connectivity for a wide range of devices. Significance of Wi-Fi lies in providing convenient and flexible Internet access, allowing seamless communication, data transfer, and online activities. Wi-Fi has become a cornerstone for connectivity in homes, businesses, public spaces, and educational institutions, enhancing productivity and connectivity for individuals and organizations alike.

Over time, the importance of Wi-Fi has evolved in tandem with technological advancements. The increasing demand for faster speeds, greater bandwidth, and improved security has driven the development of more advanced Wi-Fi standards. However, as technology progresses, the demands of Wi-Fi standards and technologies require increasing evolution in order to provide enhanced performance, increased capacity, and better efficiency. Specifically, a wireless network may require seamless communication between an access point and a station. The access point can evaluate the evolving requirements of the station and assess whether current network conditions are adequate to meet the requirements. Additionally, the access point may adjust network conditions dynamically in real-time or near real-time to ensure optimal performance for the station.

Current solutions for information exchange between the access point and the station may be adequate for simpler network environments, where demands for data throughput, low latency, and user experience are less demanding. These solutions may incorporate basic mechanisms to facilitate the exchange of information between the station and the access point. However, as technological advancements have led to more complex networks and increased performance requirements, the existing solutions may fall short to align with evolving requirements. In various scenarios, the information exchanged between the access point and the station may be inadequate for the access point to accurately and efficiently assess the capabilities of the station.

### SUMMARY OF THE DISCLOSURE

Devices and methods for augmented information exchange in wireless networks in accordance with embodiments of the disclosure are described herein. In many embodiments, a network device may include one or more processors and a memory communicatively coupled to the one or more processors. The memory may include a communication logic that may be configured to generate a diagnostic request frame including one or more subelement fields corresponding to at least one of a device model, an Operating System (OS) version, a vendor OS version, a service provider version, a power source, or a previous session issue. The communication logic may further be configured to transmit the diagnostic request frame to a wireless device. In many additional embodiments, the communication logic may be configured to receive, from the wireless device, in response to the diagnostic request frame, a diagnostic report frame comprising a set of attributes associated with the one or more subelement fields.

In a number of embodiments, the network device may include an access point.

In a variety of embodiments, the wireless device may include a station.

In various embodiments, based on the one or more subelement fields corresponding to the device model, an attribute of the set of attributes may include a model identifier of the wireless device.

In more embodiments, based on the one or more subelement fields corresponding to the OS version, an attribute of the set of attributes may include a version identifier of a primary OS of the wireless device.

In additional embodiments, based on the one or more subelement fields corresponding to the vendor OS version, an attribute of the set of attributes may include a version identifier of a vendor-specific OS of the wireless device.

In further embodiments, based on the one or more subelement fields corresponding to the service provider version, an attribute of the set of attributes may include an identifier for a service provider software version of the wireless device.

In still more embodiments, based on the one or more subelement fields corresponding to the power source, an attribute of the set of attributes may include an indication for a source of power of the wireless device.

In still further embodiments, based on the one or more subelement fields corresponding to the previous session issue, an attribute of the set of attributes may include one or more of a failure epoch timestamp, a Basic Service Set Identifier (BSSID), a signal characteristic indicator corresponding to a peer device, or a reason associated with an issue encountered in a previous wireless session of the wireless device.

In still additional embodiments, the communication logic may further be configured to receive the diagnostic report frame via a Medium Access Control Layer Management Entity (MLME) interface.

In some more embodiments, the one or more subelement fields may further correspond to a device type.

In yet various embodiments, based on the one or more subelement fields further corresponding to the device type, an attribute of the set of attributes classifies the wireless device as one of a tablet, a static sensor, a mobile sensor, a static emergency device, a mobile emergency device, an Augmented Reality/Virtual Reality (AR/VR) device, a smartwatch, a smart wearable, a smart appliance, or a smart assistant.

In yet more embodiments, the communication logic may further be configured to analyze the received diagnostic report frame, generate a diagnostic analysis report based on the analysis, and transmit the diagnostic analysis report to the wireless device.

In still yet more embodiments, the diagnostic analysis report may include one or more of a device status information, one or more network performance metrics, or one or more system logs associated with the wireless device.

In still various embodiments, the diagnostic request frame may correspond to a wireless frame.

In one or more embodiments, the wireless frame may correspond to one of an association response frame or a reassociation response frame.

In several embodiments, a wireless device may include one or more processors and a memory communicatively coupled to the one or more processor. The memory may include a communication logic. The communication logic may be configured to generate a diagnostic report frame includes a set of attributes indicating one or more of a device model, an Operating System (OS) version, a vendor OS version, a service provider version, a power source, or a previous session issue associated with the wireless device. The communication logic may further be configured to transmit the diagnostic report frame to a network device.

In yet several embodiments, the diagnostic report frame may correspond to one of a protected wireless frame or an unprotected wireless frame.

In numerous embodiments, the diagnostic report frame may correspond to one of a solicited response frame or an unsolicited response frame.

In still numerous embodiments, a method may include generating a diagnostic request frame including one or more subelement fields corresponding to at least one of a device model, an Operating System (OS) version, a vendor OS version, a service provider version, a power source, or a previous session issue. The method may further include transmitting the diagnostic request frame to a wireless device. The method may also include receiving, from the wireless device, in response to the diagnostic request frame, a diagnostic report frame comprising a set of attributes associated with the one or more subelement fields.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system in accordance with various embodiments of the disclosure;

FIG. 2 is a conceptual depiction of a communication layer architecture in accordance with various embodiments of the disclosure;

FIG. 3 is a conceptual network diagram of various environments that a networking logic may operate on a plurality of network devices in accordance with various embodiments of the disclosure;

FIG. 4 is a flow diagram illustrating an augmented information exchange between a network device and a wireless device in accordance with various embodiments of the disclosure;

FIG. 5 is a diagram that illustrates a message format of a wireless request frame transmitted by a network device to a wireless device in accordance with various embodiments of the disclosure;

FIG. 6 is a diagram that illustrates a message format of a wireless report frame transmitted by a wireless device to a network device in accordance with various embodiments of the disclosure;

FIG. 7 is a diagram that illustrates a message format of a device model subelement in accordance with various embodiments of the disclosure;

FIG. 8 is a diagram that illustrates a message format of an Operating System (OS) version subelement in accordance with various embodiments of the disclosure;

FIG. 9 is a diagram that illustrates a message format of a vendor OS version subelement in accordance with various embodiments of the disclosure;

FIG. 10 is a diagram that illustrates a message format of a service provider version subelement in accordance with various embodiments of the disclosure;

FIG. 11 is a diagram that illustrates a message format of a power source subelement in accordance with various embodiments of the disclosure;

FIG. 12 is a diagram that illustrates a message format of a previous session issue subelement in accordance with various embodiments of the disclosure;

FIG. 13 is a flowchart depicting a process for receiving a diagnostic report frame including a set of data attributes associated with one or more subelement fields in accordance with various embodiments of the disclosure;

FIG. 14 is a flowchart depicting a process for generating a diagnostic analysis report in accordance with various embodiments of the disclosure;

FIG. 15 is a flowchart depicting a process for decrypting a diagnostic report frame in accordance with various embodiments of the disclosure;

FIG. 16 is a flowchart depicting a process for transmitting a diagnostic report frame to a network device in accordance with various embodiments of the disclosure;

FIG. 17 is a flowchart depicting a process for receiving a diagnostic analysis report from a network device in accordance with various embodiments of the disclosure; and

FIG. 18 is a conceptual block diagram of a device capable of executing components and a communication logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well- understood, elements that are useful or necessary in a commercially feasible embodiment are often not depicted to facilitate a less obstructed view of these various embodiments of the present disclosure.

### DETAILED DESCRIPTION

In response to the issues described above, systems and methods are discussed herein for augmented information exchange in a wireless network. Current solutions for information exchange between an access point and a station may be adequate for simpler network environments, where demands for data throughput, low latency, and user experience are less critical. These solutions may incorporate mechanisms to facilitate the exchange of information between the station and the access point. However, as technological advancements have led to more complex networks and increased performance requirements, the existing solutions may be inefficient. In various scenarios, the information exchanged between the access point and the station may be inadequate for the access point to accurately and efficiently assess the capabilities of the station.

Thus, in many embodiments, an augmented information exchange in a wireless network is provided. Various wireless frames, including beacon, probe request, and response frames, are exchanged between a network device (e.g., an access point) and a wireless device (e.g., a station) to enable the augmented exchange of information. In yet many embodiments, the wireless device may initiate communication by transmitting a (re)association request to the network device when attempting to connect or reconnect. Upon successful (re)association, the network device may respond with a (re)association response. Following successful (re)association, the network device may generate a diagnostic request frame to obtain information from the wireless device for troubleshooting or network optimization. The diagnostic request frame may request data corresponding to a device type, a device model, an Operating System (OS) version, a vendor OS version, a service provider version, a power source, or a previous session issue, or the like.

In various embodiments, upon receiving the diagnostic request frame, the wireless device may generate a diagnostic report frame including requested attributes. These attributes may allow the network device to evaluate performance, identify potential issues, and optimize network operations. The exchange of augmented information may enhance network management and performance by providing detailed insights about the wireless device. This functionality my support more precise troubleshooting, better network optimization, and improved diagnostic capabilities, particularly in the context of Ultra High Reliability (UHR) network operations. In several embodiments, the wireless device can also transmit the diagnostic report frame to the network device in an unsolicited manner, for example, without receiving the diagnostic request frame.

In yet various embodiments, the network device may request log event data from the wireless device through wireless frames. These frames may include information related to roaming events, disconnection events, and other relevant network activities. This capability can enhance the network device's ability to diagnose connectivity issues, troubleshoot problems more efficiently, and optimize overall network performance and functionality. In more embodiments. the network device may also request specific communication statistics from the wireless device using enhanced query mechanisms. This may allow more granular and flexible data requests for precise network performance monitoring. Overall, the augmented exchange of information may support better network management, optimized performance, and efficient diagnostics, ensuring improved functionality across various device types and network configurations.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non- host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

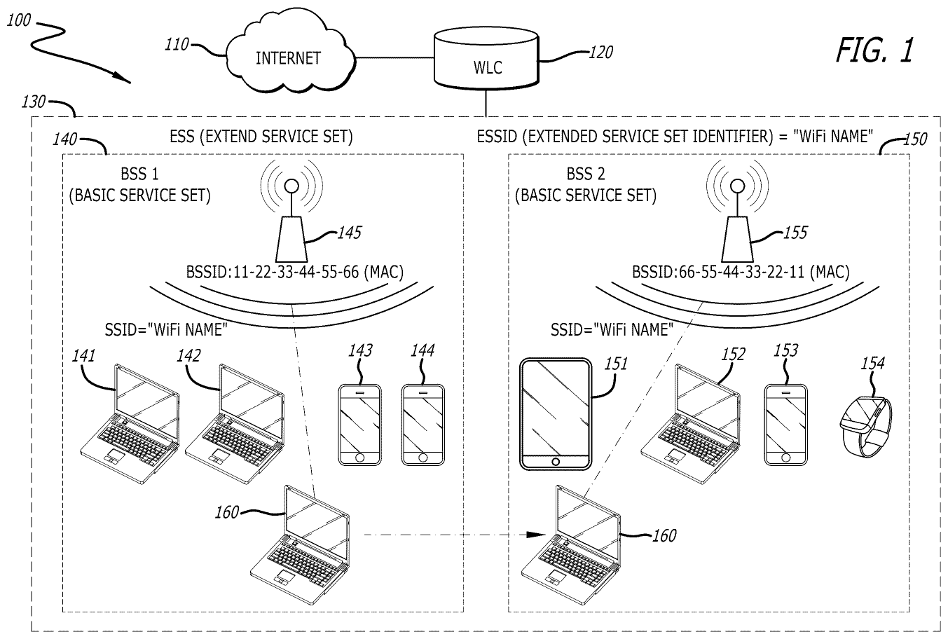

Referring to FIG. 1, a schematic block diagram of a wireless local networking system 100 in accordance with various embodiments of the disclosure is shown. Wireless local networking standards play a crucial role in enabling seamless communication and connectivity between various devices within localized areas. One of the most prevalent standards is Wi-Fi, is based on the IEEE 802.11 family of protocols. Wi-Fi provides high-speed wireless access to the internet and local network resources, with iterations such as 802.11a, 802.11b, 802.11g, 802.11k, 802.11n, 802.11v, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes-comprising devices like laptops, smartphones, or other Wi-Fi-enabled devices-operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

A basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

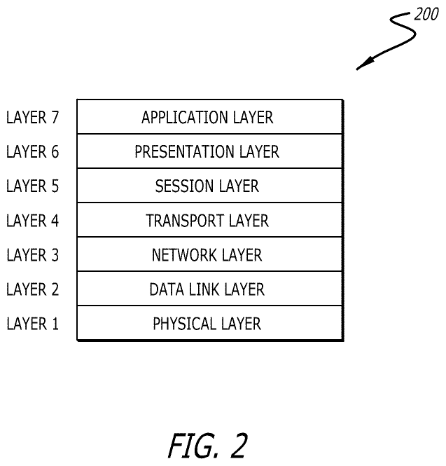

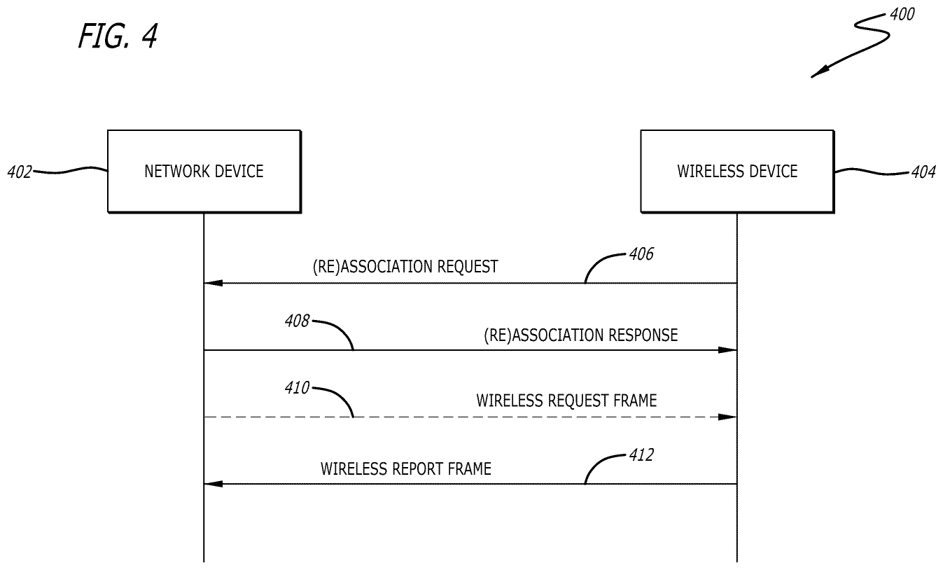

The network can include a variety of user end devices that connect to the network. These devices can sometimes be referred to as stations (i.e., “STAs”). Each device is typically configured with a medium access control (“MAC”) address in accordance with the IEEE 802.11 standard. As described in more detail in FIG. 2, a physical layer can also be configured to communicate over the wireless medium. As described in more detail of FIG. 4, various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BSS 2 150). The ESS 130, BSS 1 140 and BSS 2 150 all broadcast and are configured with the same SSID “WiFi Name”, which can be a BSSID for each of the BSS 1 140 and BSS 2 150 as well as a ESSID for the ESS 130.

Within the BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the BSS 2 150, the network comprises a first tablet 151 (shown as “tablet1”), a fourth notebook 152 (shown as “notebook4”), a third phone 153 (shown as “phone3”), and a first watch 154 (shown as “watch1”), which can communicate with a second access point 155. The third notebook 160 is communicatively collected to both the BSS 1 140 and BSS 2 150. In this setup, third notebook 160 can be seen to “roam” from the physical area serviced by the BSS 1 140 and into the physical area serviced by the BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-18 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the fourth transport layer, can be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer, can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. The elements depicted in FIG. 2 may also be interchangeable with other elements of FIG. 1 and FIGS. 3-18 as required to realize a particularly desired embodiment.

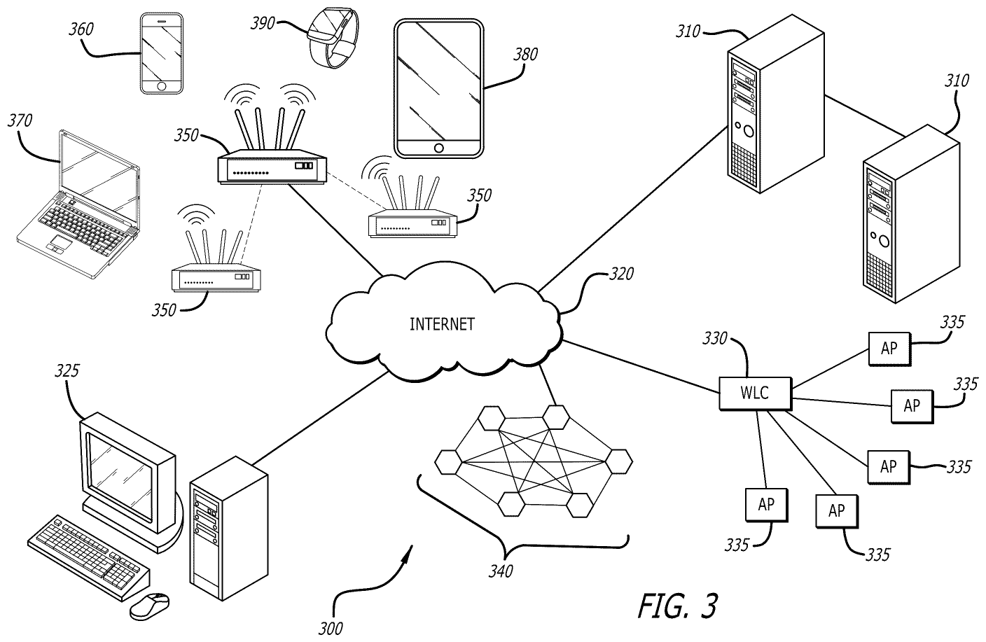

Referring to FIG. 3, a conceptual network diagram 300 of various environments that a communication logic may operate on a plurality of network devices in accordance with various embodiments of the disclosure is shown. Those skilled in the art will recognize that the communication logic can include various hardware and/or software deployments and can be configured in a variety of ways. In many embodiments, the communication logic can be configured as a standalone device, exist as a logic in another network device, be distributed among various network devices operating in tandem, or remotely operated as part of a cloud-based network management tool. In further embodiments, one or more servers 310 can be configured with the communication logic or can otherwise operate as the communication logic. In many embodiments, the communication logic may operate on one or more servers 310 connected to a communication network 320 (shown as the “Internet”). The communication network 320 can include wired networks or wireless networks. The communication logic can be provided as a cloud-based service that can service remote networks, such as, but not limited to a deployed network 340.

However, in additional embodiments, the communication logic may be operated as a distributed logic across multiple network devices. In the embodiment depicted in FIG. 3, a plurality of network access points (APs) 350 can operate as the communication logic in a distributed manner or may have one specific device operate as the communication logic for all of the neighboring or sibling APs 350. The APs 350 may facilitate Wi-Fi connections for various electronic devices, such as but not limited to, mobile computing devices including laptop computers 370, cellular phones 360, portable tablet computers 380 and wearable computing devices 390.

In further embodiments, the communication logic may be integrated within another network device. In the embodiment depicted in FIG. 3, a wireless LAN controller (WLC) 330 may have an integrated communication logic that the WLC 330 can use to monitor or control power consumption of the APs 335 that the WLC 330 is connected to, either wired or wirelessly. In still more embodiments, a personal computer 325 may be utilized to access and/or manage various aspects of the communication logic, either remotely or within the network itself. In the embodiment depicted in FIG. 3, the personal computer 325 communicates over the communication network 320 and can access the communication logic of the servers 310, or the network APs 350, or the WLC 330.

Although a specific embodiment for various environments that the communication logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the networking logic may be provided as a device or software separate from the WLC 330 or the networking logic may be integrated into the WLC 330. The elements depicted in FIG. 3 may also be interchangeable with other elements of FIGS. 1-2 and FIGS. 4-18 as required to realize a particularly desired embodiment.

Referring to FIG. 4, a flow diagram 400 illustrating an augmented information exchange between a network device 402 and a wireless device 404 in a communication network in accordance with various embodiments of the disclosure is shown. In various embodiments, the network device 402 may be an access point (for example, a Wi-Fi Router, a Wi-Fi Range Extender, a mesh Wi-Fi node, a cellular hotspot, a network bridge, or the like), and the wireless device 404 may be a station (for example, a user device, a client device, an endpoint device, an Internet of thing “IoT” device, or the like.). In a number of embodiments, the network device 402 may include a communication logic to facilitate communication with the wireless device 404 and additional devices within the communication network. For example, the communication network may include a wireless network.

In many embodiments, the network device 402 and the wireless device 404 may exchange various wireless frames to facilitate augmented information exchange. The wireless frames may include, for example, beacon frames, probe response frames, probe request frames, or the like. In a scenario where the wireless frames are beacon frames, the wireless frames can be broadcasted or transmitted unsolicited by the network device 402 or the wireless device 404. However, if the wireless frames are probe response frames, the wireless frames can be unicasted by the wireless device 404 to the network device 402 as responses to one or more probe request frames received from the network device 402. Additionally, the wireless frames can also be unicasted by the network device 402 to the wireless device 404 as responses to one or more probe request frames received from the wireless device 404.

In yet various embodiments, the wireless device 404 may be configured to transmit a (re)association request 406 to the network device 402. The wireless device 404 may transmit the (re)association request 406 within a wireless frame. In several embodiments, the wireless device 404 may transmit the (re)association request 406 to the network device 402 when attempting to establish or re-establish a connection with the network device 402. In more embodiments, the wireless device 404 may transmit the (re)association request 406 to the network device 402 either when joining the communication network for the first time or when re-associating with the network device 402 after disconnecting from a previous connection. In a non-limiting example, the (re)association request 406 may include information related to the wireless device 404, such as security credentials and other identifying details, which the network device 402 may use to authenticate and associate with the wireless device 404.

In still more embodiments, the network device 402 may transmit a (re)association response 408 to the wireless device 404 based on the (re)association request 406. In some more embodiments, the (re)association response 408 may indicate either a successful or failed association. The network device 402 may transmit the (re)association response 408 in a wireless frame. In an example, the (re)association response 408 can be an association response for a first time connection. In more examples, the (re)association response 408 can be a reassociation response for a reconnection.

In further embodiments, the network device 402 may be configured to generate a diagnostic request frame once the (re)association with the wireless device 404 is successfully established. In many further embodiments, the network device 402 may generate the diagnostic request frame for network management or troubleshooting operations. In various scenarios, the diagnostic request frame may solicit specific information from the wireless device 404, which can assist the network device 402 in performing diagnostics, optimizing network performance, and addressing other operational needs. In yet many embodiments, the diagnostic request frame may include one or more information elements. For example, the diagnostic request frame may include a diagnostic request element. In yet many further embodiments, the diagnostic request frame may include one or more subelement fields (for example, subelement field(s) of the diagnostic request element) corresponding to at least one of a device type, a device model, an OS version, a vendor OS version, a service provider version, a power source, or a previous session issue. The one or more subelement fields may provide the network device 402 with information, enabling the network device 402 to collect details related to the wireless device 404, such as the device type, the device model, the OS version, the vendor OS version, the service provider version, the power source, or the previous session issue. The collected data may enable the network device 402 to perform diagnostics, troubleshoot potential problems, and optimize network performance based on the specific characteristics of the wireless device 404.

In several embodiments, the network device 402 may transmit the diagnostic request frame to the wireless device 404. In yet more embodiments, the network device 402 may transmit the diagnostic request frame as a wireless request frame 410, for example, a management frame or an action frame. In still various embodiments, the network device 402 may be configured to encrypt the diagnostic request frame before transmitting the diagnostic request frame to the wireless device 404. Encrypting the diagnostic request frame before transmitting may ensure that only the wireless device 404 can access the diagnostic request frame. The network device 402 may utilize one or more known encryption algorithms, for example, symmetric key encryption algorithm, asymmetric key encryption algorithm, HASH-based encryption algorithm, or the like, to encrypt the diagnostic request frame. Further, the network device 402 may ensure that the transmitted diagnostic request frame is decryptable by the wireless device 404.

In yet various embodiments, the network device 402 may transmit the diagnostic request frame to the wireless device 404 to initiate a diagnostic operation. The diagnostic operation may refer to a process of identifying, analyzing, and resolving issues related to the connectivity of the wireless device 404 and network performance. For example, the diagnostic operation may include troubleshooting connectivity issues, identifying sources of interference, optimizing network performance, or assessing other factors that could impact the operation of the wireless device 404.

In several additional embodiments, the wireless device 404 may include a communication logic to facilitate communication with the network device 402 and other devices within the communication network. The wireless device 404 may be configured to receive the diagnostic request frame from the network device 402. In further embodiments, the diagnostic request frame may correspond to one of a protected wireless frame or an unprotected wireless frame. A protected wireless frame may refer to a frame that has been encrypted. An unprotected wireless frame may refer to a frame that has not been encrypted. In numerous embodiments, if the diagnostic request frame is a protected frame (for example, an encrypted frame), the wireless device 404 may be configured to decrypt the diagnostic request frame. The wireless device 404 may utilize one or more known decryption algorithms, for example, symmetric key decryption algorithm, asymmetric key decryption algorithm, HASH-based decryption algorithm, or the like, to decrypt the diagnostic request frame.

In more embodiments, the wireless device 404 may be configured to generate a diagnostic report frame in response to receiving the diagnostic request frame from the network device 402. The diagnostic report frame may include a set of attributes corresponding to one or more subelement fields requested by the network device 402. For example, the diagnostic report frame may include a set of attributes indicating one or more of the device type, the device model, the OS version, the vendor OS version, the service provider version, the power source, or the previous session issue associated with the wireless device 404.

In many more embodiments, based on the device type, an attribute of the set of attributes within the diagnostic report frame may classify the wireless device 404 into one of a tablet, a static sensor, a mobile sensor, a static emergency device, a mobile emergency device, an Augmented Reality/Virtual Reality (AR/VR) device, a smartwatch, a smart wearable, a smart appliance, or a smart assistant. Other possible classifications of the wireless device 404 may include, but are not limited to, a Heads-Up Display (HUD), a Head-Mounted Display (HMD), a sports or activity tracker, a health monitoring device, an environmental sensor, a smart home or building Internet of Things (sensor), a smart light, a smart power device, a mobile IoT device, or a static IoT device.

In still various embodiments, based on the device model, an attribute of the set of attributes within the diagnostic report frame may include a model identifier of the wireless device 404. For example, if the wireless device 404 is a specific model of a tablet, the model identifier may be a unique string or number that identifies the model of the tablet. In still more embodiments, based on the OS version, an attribute of the set of attributes within the diagnostic report frame may include a version identifier of a primary OS of the wireless device 404. The version identifier of the primary OS may allow the network device 402 to determine the specific version of the OS running on the wireless device 404, thereby enabling the network device 402 to assess potential compatibility or performance issues associated with the OS version.

In further embodiments, based on the vendor OS version, an attribute of the set of attributes within the diagnostic report frame may include a version identifier of a vendor-specific OS of the wireless device 404. For example, the version identifier of the vendor-specific OS may provide insights into device-specific features, performance optimizations, or known issues related to the vendor-specific OS. In several more embodiments, based on the service provider version, an attribute of the set of attributes within the diagnostic report frame may include an identifier for a service provider software version of the wireless device 404. For example, the identifier for the service provider software version may enable the network device 402 to diagnose issues related to carrier-specific features, configurations, or compatibility between the service provider's network and the wireless device 404.

In several additional embodiments, based on the power source, an attribute of the set of attributes within the diagnostic report frame may include an indication for a source of power of the wireless device 404. An example of the power source may include a mains power or a battery power. In additional embodiments, based on the previous session issue, an attribute of the set of attributes within the diagnostic report frame may include one or more of a failure epoch timestamp, a Basic Service Set Identifier (BSSID), a signal characteristic indicator corresponding to a peer device, or a reason associated with an issue encountered in a previous wireless session of the wireless device 404. The signal characteristic indicator may be indicative of one or more of a signal strength or a signal quality. Examples of the signal characteristic indicator include, but are not limited to, a Received Signal Strength Indicator (RSSI), a Received Channel Power Indicator (RCPI), a Received Signal-to-Noise Indicator (RSNI), a Signal-to-Noise Ratio (SNR), a Signal-to-Interference-plus-Noise Ratio (SINR), and a Signal-to-Interference Ratio (SIR).

In several more embodiments, the wireless device 404 may transmit the diagnostic report frame to the network device 402. In several embodiments, the wireless device 404 may transmit the diagnostic report frame as a wireless report frame 412, for example, a management action frame. In still yet more embodiments, the diagnostic request frame may correspond to one of a protected wireless frame (for example, an encrypted wireless frame) or an unprotected wireless frame (for example, an unencrypted wireless frame). In one or more embodiments, the wireless device 404 may be configured to encrypt the diagnostic report frame before transmitting the diagnostic report frame to the network device 402.

In numerous embodiments, the diagnostic report frame may correspond to one of a solicited response frame or an unsolicited response frame. In some more embodiments, the wireless device 404 may not necessarily receive the wireless request frame 410 (or the diagnostic request frame) from the network device 402 before transmitting the diagnostic report frame. Upon successfully associating with the network device 402, the wireless device 404 may proactively transmit the wireless report frame 412 to the network device 402 without any request or demand from the network device 402. The unsolicited transmission of the diagnostic report frame may ensure that the network device 402 receives updates, status information, or diagnostic data from the wireless device 404 immediately upon the (re)association, facilitating real-time or near-real-time monitoring, diagnostics, and performance assessments of the wireless device 404.

In yet further embodiments, the network device 402 may receive the wireless report frame 412 (for example, the diagnostic report frame) from the wireless device 404. The diagnostic report frame may include the set of attributes associated with the one or more subelement fields. If the received diagnostic report frame is encrypted, the network device 402 may employ a decryption technique or a decryption algorithm to decrypt the diagnostic report frame. In yet various embodiments, the network device 402 may receive the diagnostic report frame via a Medium Access Control Layer Management Entity (MLME) interface.

In many further embodiments, the network device 402 may analyze the received diagnostic report frame and generate a diagnostic analysis report based on the analysis. In examples, the diagnostic analysis report may include one or more of a device status information, one or more network performance metrics, or one or more system logs associated with the wireless device 404. For example, the diagnostic analysis report may include information associated with the wireless device 404, such as an operational state, connectivity status, signal strength, data throughput, latency, packet loss, etc. In additional embodiments, the diagnostic analysis report may enable the network device 402 to perform the diagnostic operation and troubleshooting for the wireless device 404, for example, for the previous session issue.

In yet several more embodiments, the network device 402 may transmit the diagnostic analysis report to the wireless device 404. The network device 402 may transmit the diagnostic analysis report to the wireless device 404 to notify the wireless device 404 about the diagnostic analysis results, recommend improvements or adjustments for optimal performance, or provide relevant troubleshooting steps. In yet more embodiments, the network device 402 may transmit the diagnostic analysis report in a wireless frame.

In yet many additional embodiments, the diagnostic request and report exchange framework may facilitate an enhanced exchange of information between the network device 402 and the wireless device 404, thereby improving the efficiency and accuracy of network management. The inclusion of specific subelement fields such as device model, OS version, vendor OS version, service provider version, power source, and previous session issues may provide the network device 402 with information about the wireless device 404. The attributes corresponding to these fields may enable the network device 402 to conduct in-depth diagnostics, optimize network performance, and address operational challenges that may arise from the unique characteristics of the wireless device 404. Additionally, the categorization of device type, such as tablet, static sensor, mobile sensor, static emergency device, mobile emergency device, AR/VR device, smartwatch, smart wearable, smart appliance, or smart assistant, may further enhance the functionality of the network device 402 to perform the diagnostic operation according to the requirements of various device types. This augmented information exchange may improve diagnostic capabilities, troubleshooting procedures, and overall network performance.

In still yet various embodiments, the network device 402 may generate a Wireless Network Management (WNM) log request frame including one or more subelement fields. The one or more subelement fields may indicate a specific type of log event that is of interest to the network device 402. In examples, the one or more subelement fields may correspond to at least one of a last roam event, a last disconnection event, or last N events (for example, last N 802.11 events). The last roam event field may enable the network device 402 to request data regarding the most recent roaming event, such as time, reason, or network conditions that prompted the roaming event. The last disconnection event field may enable the network device 402 to request data regarding the last disconnection event, including reasons for disconnection, a timestamp associated with the disconnection, and associated network information. The last N 802.11 events field may enable the network device 402 to request the last N 802.11 events, such as authentication attempts, (re)association/disassociation events, and other relevant event data. In several embodiments, the network device 402 may transmit the WNM log request frame to the wireless device 404. In more embodiments, the network device 402 may transmit the WNM log request frame as a wireless frame.

In still yet more embodiments, the wireless device 404 may be configured to generate a WNM log report frame in response to receiving the WNM log request frame from the network device 402. The WNM log report frame may include a set of attributes corresponding to one or more subelement fields requested by the network device 402. In some more embodiments, the WNM log report frame may include a set of attributes indicating one or more of the last roam event, the last disconnection event, or the last N events. In several embodiments, the wireless device 404 may transmit the WNM log report frame to the network device 402 for further analysis. In one or more embodiments, the wireless device 404 may transmit the WNM log report frame to the network device 402 as a wireless frame.

In further additional embodiments, the network device 402 may generate a statistics report request frame (also referred to as 802.11k statistics report request frame) and transmit the statistics report request frame to the wireless device 404. In yet many further embodiments, the statistics report request frame may include a Group Identity value. When the Group Identity value is selected, the statistics report request frame may include a subelement that lists a series of sets. Each set in the subelement may correspond to a group identity and statistic attributes associated with that group, such as {group identity, statistic attributes}. For example, the subelement may include a set such as {7, 3, 1, 2, 3}, which may indicate that the network device 402 is querying ‘3’ statistic attributes from Group ‘7’, namely statistic attributes ‘1’, ‘2’, and ‘3’ (for example, dot11QoStransmittedFragmentCount, dot11QoSFailedCount, and dot11QoSRetryCount). In yet additional embodiments, the subelement may specify the number of items queried and the index of each item within its corresponding group identity. For example, a subelement such as {2, 7, 3, 1, 2, 3, 10, 2, 4, 6} may indicate that the network device 402 is querying statistic attributes from two groups: Group ‘7’, which includes ‘3’ statistic attributes (‘1’, ‘2’, ‘3’), and Group ‘10’, which includes ‘2’ statistics (‘4’ and ‘6’). This enhanced query mechanism may allow for a more flexible and granular selection of statistics across different groups, enabling the network device 402 to request precise data from various statistical categories based on specific needs from the wireless device 404.

In several more embodiments, the statistics report request frame may include any number of available groups, new target groups, such as Specific Communication Statistics (SCS), and associated counters for each group. The inclusion of the new groups further enhances the functionality of the network device 402 to monitor and manage network performance by providing additional metrics and statistics, improving the overall functionality and diagnostic capabilities.

Although a specific embodiment for augmented information exchange between a network device and a wireless device in a communication network suitable for carrying out the various steps, processes, methods, and operations described herein is discussed with respect to FIG. 4, any of a variety of systems and/or processes may be utilized in accordance with embodiments of the disclosure. For example, transmitting the wireless request frame (for example, the diagnostic request frame) may be optional. In various embodiments, the diagnostic request frame may be included in the (re)association response frame (e.g., an association response frame for a first time connection or a reassociation response frame for reconnection). The elements depicted in FIG. 4 may also be interchangeable with other elements of FIGS. 1-3 and FIGS. 5-18 as required to realize a particularly desired embodiment.

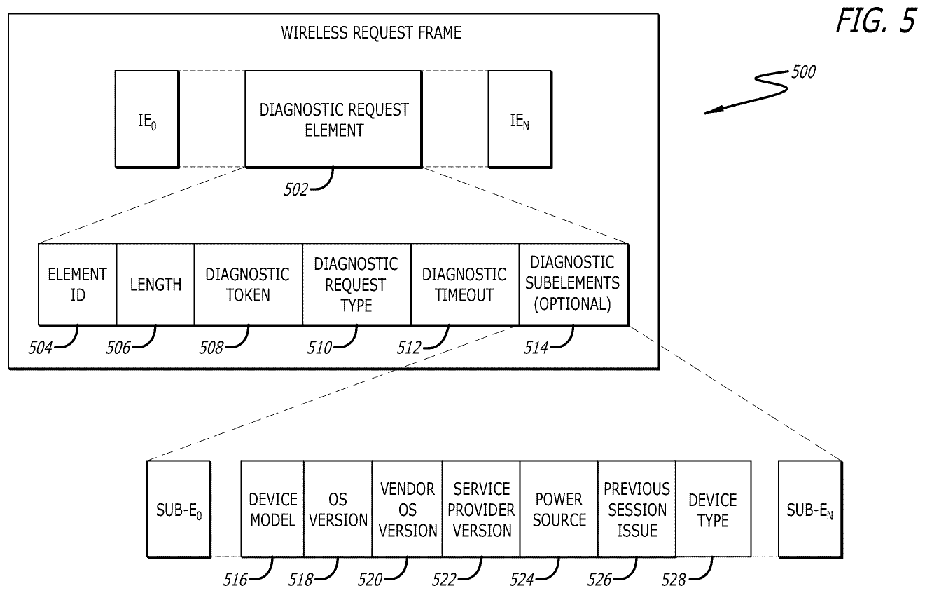

Referring to FIG. 5, a diagram that illustrates a message format of a wireless request frame 500 transmitted by a network device to a wireless device in accordance with various embodiments of the disclosure is shown. In various embodiments, the network device (for example, the network device 402 of FIG. 4) may receive a (re)association request from the wireless device (for example, the wireless device 404 of FIG. 4). Upon receiving the (re)association request, the network device may transmit a (re)association response to the wireless device. For example, the (re)association response may indicate a successful (re)association or a failed (re)association. Upon successful (re)association between the network device and the wireless device, the network device may be configured to generate the wireless request frame 500. The wireless request frame 500 may include one or more subelement fields. For example, the wireless request frame 500 may be generated to obtain a set of attributes associated with one or more subelement fields from the wireless device. In a number of embodiments, the wireless request frame 500 may be equivalent to the diagnostic request frame described in FIG. 4.

In many embodiments, the network device may transmit the wireless request frame 500 to the wireless device. For example, the network device may transmit the wireless request frame 500 to the wireless device to initiate a diagnostic operation. The diagnostic operation may refer to a process of identifying, analyzing, and resolving issues related to the wireless device's connectivity and network performance. For example, the diagnostic operation may include troubleshooting connectivity issues, identifying sources of interference, optimizing network performance, or assessing other factors that could impact the wireless device's operation. The diagnostic operation may ensure that the wireless device functions properly and maintains optimal network performance. The wireless request frame 500 may include one or more instructions or requests related to performing the diagnostic operation on the wireless device.

As shown in FIG. 5, the wireless request frame 500 may include information elements IE₀-IE_{N}. In yet various embodiments, the wireless request frame 500 may also include a specialized information element, for example, a diagnostic request element 502. The diagnostic request element 502 may include a plurality of subelement fields and subfields. In an example embodiment, the diagnostic request element 502 may include various fields such as element ID 504, length 506, diagnostic token 508, diagnostic request type 510, diagnostic timeout 512, and diagnostic subelements 514. The element ID 504 field (occupying one octet, for example) may be a value or a code that uniquely identifies the diagnostic request element 502 and may enable a correct interpretation of the wireless request frame 500 at the wireless device. The length 506 field (occupying one octet, for example) may specify the size of the diagnostic request element 502. The length 506 field may enable precise parsing of the contents of the diagnostic request element 502 at the wireless device. Following this, the diagnostic token 508 field (occupying one octet, for example) may enable tracking status or results of the wireless request frame 500. The diagnostic request type 510 field occupying one octet, for example) may indicate a type or nature of the diagnostic operation requested by the wireless request frame 500. The diagnostic timeout 512 field (occupying two octets, for example) may specify a time frame (for example, 1 to 5 seconds) that the network device should wait for a response after sending the wireless request frame 500. If a response is not received within this time frame, the diagnostic operation may be aborted or retried, depending on the network device's configuration.

Further, the diagnostic subelements 514 field may occupy, for example, a variable number of octets and include subelement fields SUB-E₀-SUB-E_{N}. In many examples, the multiple subelement fields may include subelement fields for device model 516, OS version 518, vendor OS version 520, service provider version 522, power source 524, previous session issue 526, and device type 528. The device model 516 subelement field may obtain information related to a specific model of the wireless device. The OS version 518 subelement field may obtain information related to a version of the OS running on the wireless device. The vendor OS version 520 subelement field may obtain information related to a version of the OS provided by the vendor (for example, a manufacturer or supplier of the wireless device). The service provider version 522 subelement field may obtain information related to a version of the service provider's software running on the wireless device. The power source 524 subelement field may obtain information related to power source of the wireless device. The previous session issue 526 subelement field may obtain information related to failures or problems encountered in a previous wireless session of the wireless device. The device type 528 subelement field may obtain information related to a category to which the wireless device belongs.

Although a specific embodiment for a message format of a wireless request frame transmitted by a network device to a wireless device suitable for carrying out the various steps, processes, methods, and operations described herein is discussed with respect to FIG. 5, any of a variety of systems and/or processes may be utilized in accordance with embodiments of the disclosure. For example, the diagnostic subelements may include additional subelement fields, such as power status subelement field, OS sub-version subelement field, version, Manufacturer Usage Description—Uniform Resource Locator (MUD-URL), etc. Further, the diagnostic subelements 514 field can include any combination of one or more subelement fields shown in FIG. 5. The elements depicted in FIG. 5 may also be interchangeable with other elements of FIGS. 1-4 and 6-18 as required to realize a particularly desired embodiment.

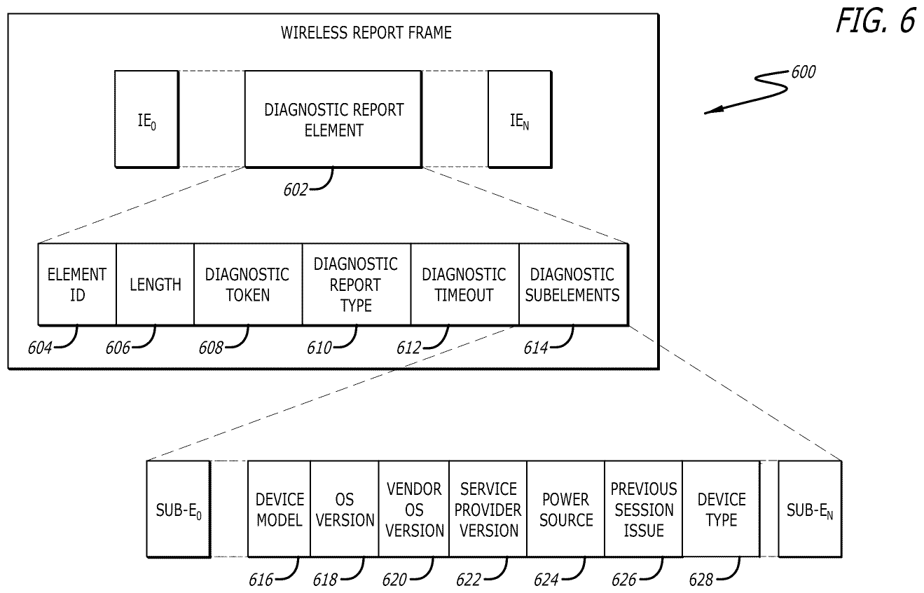

Referring to FIG. 6, a diagram that illustrates a message format of a wireless report frame 600 transmitted by a wireless device to a network device in accordance with various embodiments of the disclosure is shown. In a variety of embodiments, the wireless device (for example, the wireless device described in FIG. 5) may be configured to generate the wireless report frame 600. The wireless report frame 600 may include a set of attributes associated with one or more subelement fields. In some more embodiments, the wireless report frame 600 may be equivalent to the diagnostic report frame described in FIG. 4.

In further embodiments, the wireless device may transmit the wireless report frame 600 to the network device. In many further embodiments, the wireless device may transmit the wireless report frame 600 via a Medium Access Control Layer Management Entity (MLME) interface. In additional embodiments, the wireless device may transmit the wireless report frame 600 to the network device in response to receiving a wireless request frame from the network device. In one or more embodiments, the wireless device may be configured to proactively transmit the wireless report frame 600 to the network device, independent of any request from the network device. The wireless device may transmit the wireless report frame 600 to the network device immediately after associating with the network device. This functionality may enable real-time communication and enhances the efficiency of data reporting, ensuring that the network device receives important updates or status information without delay.

As shown in FIG. 6, the wireless report frame 600 may include information elements IE₀-IE_{N}. In several more embodiments, the wireless report frame 600 may also include a specialized information element, for example, a diagnostic report element 602. The diagnostic report element 602 may include a plurality of subelement fields and subfields. In an example embodiment, the diagnostic report element 602 may include various fields such as element ID 604, length 606, diagnostic token 608, diagnostic report type 610, diagnostic status 612, and diagnostic subelements 614. The element ID 604 field (occupying one octet, for example) may be a value or a code that uniquely identifies the diagnostic report element 602 and may enable a correct interpretation of the wireless report frame 600 at the network device. The length 606 field (occupying one octet, for example) may specify the size of the diagnostic report element 602. The length 606 field may enable precise parsing of the contents of the diagnostic report element 602 at the network device. Following this, the diagnostic token 608 field (occupying one octet, for example) may enable tracking status or results of the wireless report frame 600. The diagnostic report type 610 field occupying one octet, for example) may indicate the type of diagnostic information being reported. The diagnostic status 612 field (occupying one octet, for example) may specify whether the diagnostic request is accepted or rejected.

Further, the diagnostic subelements 614 field may occupy, for example, a variable number of octets and include subelement fields SUB-E₀-SUB-E_{N}. In many examples, the multiple subelement fields may include a set of attributes for device model 616, OS version 618, vendor OS version 620, service provider version 622, power source 624, previous session issue 626, and device type 628. An attribute associated with the device model 616 subelement field may include a model identifier of the wireless device. An attribute associated with the OS version 618 subelement field may include a version identifier of a primary OS of the wireless device. An attribute associated with the vendor OS version 620 subelement field may include a version identifier of a vendor-specific OS of the wireless device. An attribute associated with the service provider version 622 subelement field may include an identifier for a service provider software version of the wireless device. An attribute associated with the power source 624 subelement field may include an indication for a source of power of the wireless device. An attribute associated with the previous session issue 626 subelement field may include one or more of a failure epoch timestamp, a BSSID, a signal characteristic indicator corresponding to a peer device, or a reason associated with an issue encountered in a previous wireless session of the wireless device. The signal characteristic indicator may be indicative of one or more of a signal strength or a signal quality. Examples of the signal characteristic indicator include, but are not limited to, an RSSI, an RCPI, an RSNI, an SNR, an SINR, and an SIR. An attribute associated with the device type 628 subelement field may include one of a tablet, a static sensor, a mobile sensor, a static emergency device, a mobile emergency device, an AR/VR device, a smartwatch, a smart wearable, a smart appliance, or a smart assistant.

Although a specific embodiment for a message format of a wireless report frame transmitted by a wireless device to a network device suitable for carrying out the various steps, processes, methods, and operations described herein is discussed with respect to FIG. 6, any of a variety of systems and/or processes may be utilized in accordance with embodiments of the disclosure. For example, the wireless device may provide all, some, or none of the diagnostic elements specified in the diagnostic request. In numerous embodiments, an owner of the wireless device may have the option to determine whether to send all, some, or none of the attributes associated with the diagnostic elements to the network device. For example, the owner may choose to send the OS version while excluding the OS subversion. The elements depicted in FIG. 6 may also be interchangeable with other elements of FIGS. 1-5 and 7-18 as required to realize a particularly desired embodiment.

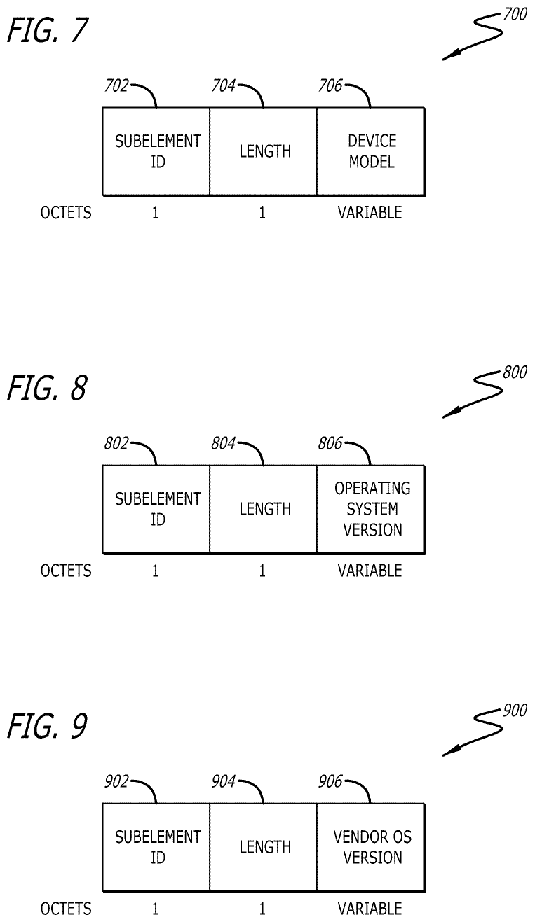

Referring to FIG. 7, a diagram that illustrates a message format of a device model subelement 700 in accordance with various embodiments of the disclosure is shown. In various embodiments, the device model subelement 700, included in a wireless report frame of a wireless device, may include a plurality of subelement fields and subfields. In an example embodiment, the device model subelement 700 may include various fields such as subelement ID 702, length 704, and device model 706. The subelement ID 702 subfield (occupying one octet, for example) may be a value or a code that uniquely identifies the device model subelement 700 and may enable a correct interpretation of the device model subelement 700 at a network device. The length 704 subfield (occupying one octet, for example) may specify the size of the device model subelement 700. The length 704 subfield may enable precise parsing of the contents of the device model subelement 700 at the network device. Following this, the device model 706 subfield (occupying a variable number of octets, for example) may include a Unicode Transformation Format—8 bits (UTS-8) string indicating a model of the wireless device.

Although a specific embodiment for a message format of a device model subelement suitable for carrying out the various steps, processes, methods, and operations described herein is discussed with respect to FIG. 7, any of a variety of systems and/or processes may be utilized in accordance with embodiments of the disclosure. For example, the device model 706 subfield may include a different character encoding format or data structure to represent the device model of the wireless device. The elements depicted in FIG. 7 may also be interchangeable with other elements of FIGS. 1-6 and 8-18 as required to realize a particularly desired embodiment.

Referring to FIG. 8, a diagram that illustrates a message format of an OS version subelement 800 in accordance with various embodiments of the disclosure is shown. In yet various embodiments, the OS version subelement 800, included in a wireless report frame of a wireless device, may include a plurality of subelement fields and subfields. In an example embodiment, the OS version subelement 800 may include various fields such as subelement ID 802, length 804, and OS version 806. The subelement ID 802 subfield (occupying one octet, for example) may be a value or a code that uniquely identifies the OS version subelement 800 and may enable a correct interpretation of the OS version subelement 800 at a network device. The length 804 subfield (occupying one octet, for example) may specify the size of the OS version subelement 800. The length 804 subfield may enable precise parsing of the contents of the OS version subelement 800 at the network device. Following this, the OS version 806 subfield (occupying a variable number of octets, for example) may include a Unicode Transformation Format—8 bits (UTS-8) string indicating an OS version of the wireless device.

Although a specific embodiment for a message format of an OS version subelement suitable for carrying out the various steps, processes, methods, and operations described herein is discussed with respect to FIG. 8, any of a variety of systems and/or processes may be utilized in accordance with embodiments of the disclosure. For example, the OS version subfield may include a different character encoding format or data structure to represent the OS version of the wireless device. The elements depicted in FIG. 8 may also be interchangeable with other elements of FIGS. 1-7 and 9-18 as required to realize a particularly desired embodiment.

Referring to FIG. 9, a diagram that illustrates a message format of a vendor OS version subelement 900 in accordance with various embodiments of the disclosure is shown. In still more embodiments, the vendor OS version subelement 900, included in a wireless report frame of a wireless device, may include a plurality of subelement fields and subfields. In an example embodiment, the vendor OS version subelement 900 may include various fields such as subelement ID 902, length 904, and vendor OS version 906. The subelement ID 902 subfield (occupying one octet, for example) may be a value or a code that uniquely identifies the vendor OS version subelement 900 and may enable a correct interpretation of the vendor OS version subelement 900 at a network device. The length 904 subfield (occupying one octet, for example) may specify the size of the vendor OS version subelement 900. The length 904 subfield may enable precise parsing of the contents of the vendor OS version subelement 900 at the network device. Following this, the vendor OS version 906 subfield (occupying a variable number of octets, for example) may include a Unicode Transformation Format—8 bits (UTS-8) string indicating a vendor-specific OS version of the wireless device.

Although a specific embodiment for a message format of a vendor OS version subelement suitable for carrying out the various steps, processes, methods, and operations described herein is discussed with respect to FIG. 9, any of a variety of systems and/or processes may be utilized in accordance with embodiments of the disclosure. For example, the vendor OS version subfield may include a different character encoding format or data structure to represent the vendor OS version of the wireless device. The elements depicted in FIG. 9 may also be interchangeable with other elements of FIGS. 1-8 and 10-18 as required to realize a particularly desired embodiment.

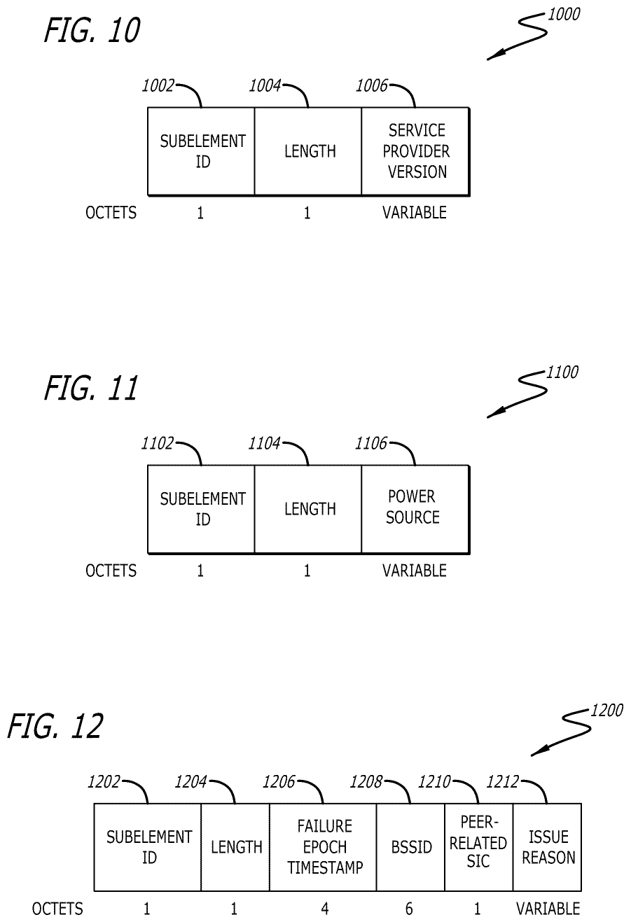

Referring to FIG. 10, a diagram that illustrates a message format of a service provider version subelement 1000 in accordance with various embodiments of the disclosure is shown. In further embodiments, the service provider version subelement 1000 may include a plurality of subelement fields and subfields. In an example embodiment, the service provider version subelement 1000, included in a wireless report frame of a wireless device, may include various fields such as subelement ID 1002, length 1004, and service provider version 1006. The subelement ID 1002 subfield (occupying one octet, for example) may be a value or a code that uniquely identifies the service provider version subelement 1000 and may enable a correct interpretation of the service provider version subelement 1000 at the network device. The length 1004 subfield (occupying one octet, for example) may specify the size of the service provider version subelement 1000. The length 1004 subfield may enable precise parsing of the contents of the service provider version subelement 1000 at a network device. Following this, the service provider version 1006 subfield (occupying a variable number of octets, for example) may include a Unicode Transformation Format—8 bits (UTS-8) string indicating a service provider software version of the wireless device.

Although a specific embodiment for a message format of a service provider version subelement suitable for carrying out the various steps, processes, methods, and operations described herein is discussed with respect to FIG. 10, any of a variety of systems and/or processes may be utilized in accordance with embodiments of the disclosure. For example, the service provider version subfield may include a different character encoding format or data structure to represent the service provider version. The elements depicted in FIG. 10 may also be interchangeable with other elements of FIGS. 1-9 and 11-18 as required to realize a particularly desired embodiment.

Referring to FIG. 11, a diagram that illustrates a message format of a power source subelement 1100 in accordance with various embodiments of the disclosure is shown. In several more embodiments, the power source subelement 1100, included in a wireless report frame of a wireless device, may include a plurality of subelement fields and subfields. In an example embodiment, the power source subelement 1100 may include various fields such as subelement ID 1102, length 1104, and power source 1106. The subelement ID 1102 subfield (occupying one octet, for example) may be a value or a code that uniquely identifies the power source subelement 1100 and may enable a correct interpretation of the power source subelement 1100 at the network device. The length 1104 subfield (occupying one octet, for example) may specify the size of the power source subelement 1100. The length 1104 subfield may enable precise parsing of the contents of the power source subelement 1100 at the network device. Following this, the power source 1106 subfield (occupying a variable number of octets, for example) may include a Unicode Transformation Format—8 bits (UTS-8) string indicating a source of power (for example, mains, battery, etc.) of the wireless device.

Although a specific embodiment for a message format of a power source subelement suitable for carrying out the various steps, processes, methods, and operations described herein is discussed with respect to FIG. 11, any of a variety of systems and/or processes may be utilized in accordance with embodiments of the disclosure. For example, the service provider version subfield may include a different character encoding format or data structure to represent a source of power of the wireless device. The elements depicted in FIG. 11 may also be interchangeable with other elements of FIGS. 1-10 and 12-18 as required to realize a particularly desired embodiment.

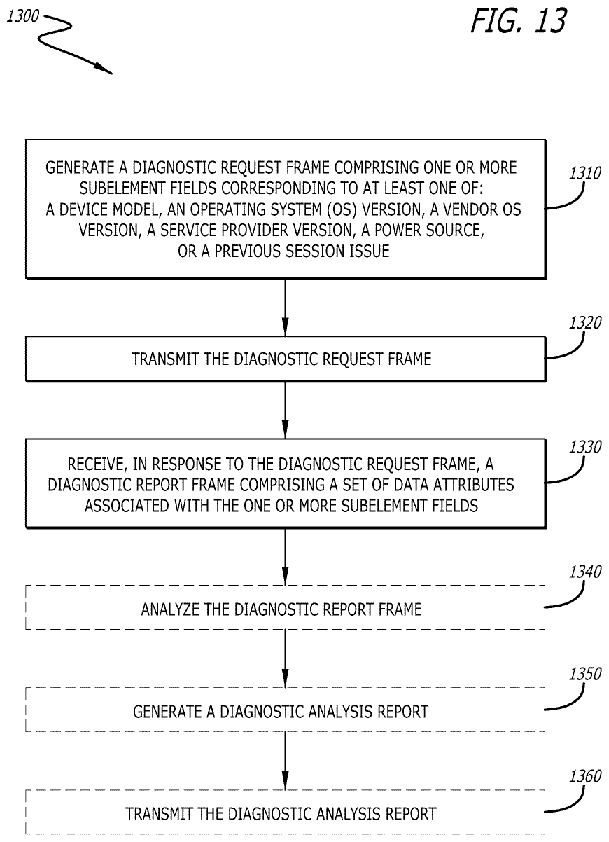

Referring to FIG. 12, a diagram that illustrates a message format of a previous session issue subelement 1200 in accordance with various embodiments of the disclosure is shown. In various embodiments, the previous session issue subelement 1200, included in a wireless report frame of a wireless device, may include a plurality of subelement fields and subfields. In an example embodiment, the previous session issue subelement 1200 may include various fields such as subelement ID 1202, length 1204, failure epoch timestamp 1206, BSSID 1208, a peer-related signal characteristic indicator (SIC) 1210, and issue reason 1212. The subelement ID 1202 subfield (occupying one octet, for example) may be a value or a code that uniquely identifies the previous session issue subelement 1200 and may enable a correct interpretation of the previous session issue subelement 1200 at a network device. The length 1204 subfield (occupying one octet, for example) may specify the size of the previous session issue subelement 1200. The length 1204 subfield may enable precise parsing of the contents of the previous session issue subelement 1200 at the network device. Following this, the failure epoch timestamp 1206 subfield (occupying four octets, for example) may specify an epoch when the reported issue occurred. The BSSID 1208 subfield (occupying six octets, for example) may identify a BSS to which the wireless device was associated at the time an issue was encountered in a previous wireless session of the wireless device. The peer-related SIC 1210 subfield (occupying one octet, for example) may represent a signal characteristic indicator corresponding to a peer device of the wireless device. The signal characteristic indicator may be indicative of one or more of a signal strength or a signal quality. Examples of the signal characteristic indicator include, but are not limited to, an RSSI, an RCPI, an RSNI, an SNR, an SINR, and an SIR. The issue reason 1212 subfield (occupying a variable number of octets, for example) may include an UTF-8 string that indicates a reason associated with an issue encountered in a previous wireless session of the wireless device.

Although a specific embodiment for a message format of a previous session issue subelement suitable for carrying out the various steps, processes, methods, and operations described herein is discussed with respect to FIG. 12, any of a variety of systems and/or processes may be utilized in accordance with embodiments of the disclosure. For example, issue reason subfield (occupying a variable number of octets, for example) may include a different character encoding format or data structure to represent a reason associated with an issue encountered in a previous wireless session of the wireless device. The elements depicted in FIG. 12 may also be interchangeable with other elements of FIGS. 1-11 and 13-18 as required to realize a particularly desired embodiment.

Referring to FIG. 13, a flowchart depicting a process 1300 for receiving a diagnostic report frame including a set of data attributes associated with one or more subelement fields in accordance with various embodiments of the disclosure is shown. In many embodiments, the process 1300 may generate a diagnostic request frame including one or more subelement fields corresponding to at least one of a device model, an Operating System (OS) version, a vendor OS version, a service provider version, a power source, or a previous session issue (block 1310). In many examples, the diagnostic request frame may correspond to a wireless frame. In several embodiments, the process 1300 may enable a network device to generate the diagnostic request frame after successful (re)association of the network device with a wireless device (for example, a station). In many examples, the network device may be an access point (e.g., a Wi-Fi Router, a Wi-Fi Range Extender, etc.), and the wireless device may be a station (e.g., (for example, smartphones, laptops, tablets, smartwatches, smart appliances, wearable devices, Internet of Things “IoT” devices, or the like). In many additional examples, the diagnostic request frame may correspond to a (re)association response frame (e.g., one of an association response frame or a reassociation response frame). In more embodiments, the process 1300 may enable the network device to generate the diagnostic request frame as a response to a (re)association request received from the wireless device.

In still more embodiments, the process 1300 may transmit the diagnostic request frame (block 1320). In some more embodiments, the process 1300 may transmit the diagnostic request frame to the wireless device. For example, the process 1300 may transmit the diagnostic request frame to the wireless device to initiate a diagnostic operation. The diagnostic operation may refer to a process of identifying, analyzing, and resolving issues related to the wireless device's connectivity and network performance. For example, the diagnostic operation may include troubleshooting connectivity issues, identifying sources of interference, optimizing network performance, or assessing other factors that could impact the wireless device's operation. The diagnostic operation may ensure that the wireless device functions properly and maintains optimal network performance.

In further embodiments, the process 1300 may receive, in response to the diagnostic request frame, a diagnostic report frame including a set of attributes associated with the one or more subelement fields (block 1330). In many further embodiments, the process 1300 may receive the diagnostic report frame from the wireless device. In additional embodiments, the process 1300 may receive the diagnostic report frame via a Medium Access Control Layer Management Entity (MLME) interface. In examples, based on the subelement field corresponding to the device model, an attribute of the set of attributes may include a model identifier of the wireless device. In further examples, based on the subelement field corresponding to the OS version, an attribute of the set of attributes may include a version identifier of a primary OS of the wireless device. In further additional examples, based on the subelement field corresponding to the vendor OS version, an attribute of the set of attributes may include a version identifier of a vendor-specific OS of the wireless device. In many examples, based on the subelement field corresponding to the service provider version, an attribute of the set of attributes may include an identifier for a service provider software version of the wireless device. In many more examples, based on the subelement field corresponding to the power source, an attribute of the set of attributes may include an indication for a source of power of the wireless device. In numerous examples, based on the subelement field corresponding to the previous session issue, an attribute of the set of attributes may include one or more of a failure epoch timestamp, a BSSID, a signal characteristic indicator corresponding to a peer device, or a reason associated with an issue encountered in a previous wireless session of the wireless device. The signal characteristic indicator may be indicative of one or more of a signal strength or a signal quality. Examples of the signal characteristic indicator include, but are not limited to, an RSSI, an RCPI, an RSNI, an SNR, an SINR, and an SIR.

In many additional embodiments, the process 1300 may analyze the diagnostic report frame (block 1340). In yet more embodiments, the process 1300 may analyze the one or more subelement fields of the diagnostic report frame to identify potential issues, failures, or areas for improvement associated with the wireless device. In examples, the one or more subelement fields may include detailed information related to the wireless devices, such as the device model, the OS version, the vendor OS version, the service provider version, the power source, and/or the previous session issue. By analyzing the one or more subelements, the process 1300 can identify potential issues that could impact functionality of the wireless device. In still various embodiments, analyzing the diagnostic report frame may be optional.

In yet various embodiments, the process 1300 may generate a diagnostic analysis report (block 1350). In a number of embodiments, the process 1300 may generate the diagnostic analysis report based on analyzing the diagnostic report frame received from the wireless device. In examples, the diagnostic analysis report may include one or more of a device status information, one or more network performance metrics, or one or more system logs associated with the wireless device. For example, the diagnostic analysis report may include information pertaining to the wireless device such as battery health, failed software updates, signal strength, a percentage of data packets lost during transmission, etc. In many embodiments, generation of the diagnostic analysis report may be optional.

In numerous embodiments, the process 1300 may transmit the diagnostic analysis report (block 1360). In several more embodiments, the process 1300 may transmit the diagnostic analysis report to the wireless device. In still yet more embodiments, the process 1300 may transmit the diagnostic analysis report to transmit the diagnostic analysis report to a central management server, a network administrator, or a monitoring system. In more embodiments, the transmitting of the diagnostic analysis report may be optional.

Although a specific embodiment for receiving a diagnostic report frame including a set of attributes associated with one or more subelement fields suitable for carrying out the various steps, processes, methods, and operations described herein is discussed with respect to FIG. 13, any of a variety of systems and/or processes may be utilized in accordance with embodiments of the disclosure. For example, before transmitting the diagnostic request frame, the process 1300 may encrypt the diagnostic request frame. The elements depicted in FIG. 13 may also be interchangeable with other elements of FIGS. 1-12 and FIGS. 14-18 as required to realize a particularly desired embodiment.

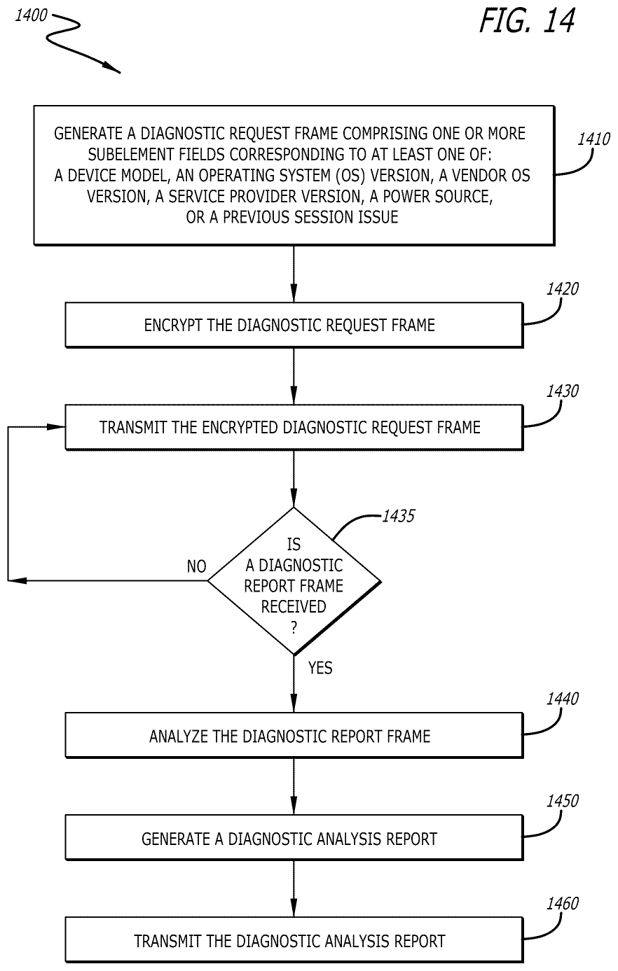

Referring to FIG. 14, a flowchart depicting a process 1400 for generating a diagnostic analysis report in accordance with various embodiments of the disclosure is shown. In various embodiments, the process 1400 may generate a diagnostic request frame including one or more subelement fields corresponding to at least one of a device model, an Operating System (OS) version, a vendor OS version, a service provider version, a power source, or a previous session issue (block 1410). In several embodiments, the process 1400 may enable a network device to generate the diagnostic request frame after successful (re)association of the network device with a wireless device. In more embodiments, the process 1400 may enable the network device to generate the diagnostic request frame as a response to a (re)association request received from the wireless device.

In yet various embodiments, the process 1400 may encrypt the diagnostic request frame (block 1420). Encrypting the diagnostic request frame before transmitting may ensure that only the intended wireless device can access the diagnostic request frame. In a number of embodiments, the process 1400 may utilize one or more known encryption algorithms, for example, symmetric key encryption algorithm, asymmetric key encryption algorithm, HASH-based encryption algorithm, or the like, to encrypt the diagnostic request frame. In many embodiments, the process 1400 may verify that the encryption algorithm used is compatible with the wireless device.

In still more embodiments, the process 1400 may transmit the encrypted diagnostic request frame (block 1430). In some more embodiments, the process 1400 may transmit the encrypted diagnostic request to the wireless device. The process 1400 may ensure that the transmitted diagnostic request frame is decryptable by the wireless device. In several embodiments, the wireless device, upon receiving the encrypted diagnostic request frame, may be configured to decrypt the diagnostic request frame, for example, utilizing a decryption algorithm.

In further embodiments, the process 1400 may determine whether a diagnostic report frame has been received (block 1435). In many further embodiments, the process 1400 may determine whether the diagnostic report frame is received from the wireless device. In additional embodiments, the diagnostic report frame may include a set of attributes indicating one or more of the device model, the OS version, the vendor OS version, the service provider version, the power source, or the previous session issue associated with the wireless device.

In several more embodiments, if it is determined that the diagnostic report frame has not been received, the process 1400 may continue to determine whether the diagnostic report frame has been received (block 1430). In yet more embodiments, the process 1400 may perform a retry mechanism or initiate a further diagnostic check to identify if there is a communication failure.

In numerous embodiments, if it is determined that the diagnostic report frame has been received, the process 1400 may analyze the diagnostic report frame (block 1440). In a number of embodiments, the process 1400 may analyze the diagnostic report frame to determine whether the diagnostic report frame received from the wireless device is encrypted. If it is determined that the diagnostic report frame is encrypted, the process 1400 may decrypt the diagnostic report frame. In many embodiments, the process 1400 may analyze the one or more subelement fields of the diagnostic report frame to identify potential issues, failures, or areas for improvement associated with the wireless device.

In yet various embodiments, the process 1400 may generate a diagnostic analysis report (block 1450). In several embodiments, the process 1400 may generate the diagnostic analysis report based on analyzing the diagnostic report frame received from the wireless device. In examples, the diagnostic analysis report may include one or more of a device status information, one or more network performance metrics, or one or more system logs associated with the wireless device. For example, the diagnostic analysis report may include information pertaining to the wireless device such as battery health, failed software updates, signal strength, a percentage of data packets lost during transmission, etc.

In still more embodiments, the process 1400 may transmit the diagnostic analysis report (block 1460). In some more embodiments, the process 1400 may transmit the diagnostic analysis report to the wireless device for further evaluation or to trigger corrective actions, such as system updates, configuration changes, or adjustments to network settings based on the analysis. In several embodiments, the process 1400 may transmit the diagnostic analysis report to transmit the diagnostic analysis report to a central management server, a network administrator, or a monitoring system to provide an overview of the wireless device's performance, enabling remote troubleshooting, monitoring, or network optimization.

Although a specific embodiment for generating a diagnostic analysis report suitable for carrying out the various steps, processes, methods, and operations described herein is discussed with respect to FIG. 14, any of a variety of systems and/or processes may be utilized in accordance with embodiments of the disclosure. For example, before transmitting the diagnostic analysis report, the process 1400 may encrypt the diagnostic analysis report. The elements depicted in FIG. 14 may also be interchangeable with other elements of FIGS. 1-13 and FIGS. 15-18 as required to realize a particularly desired embodiment.

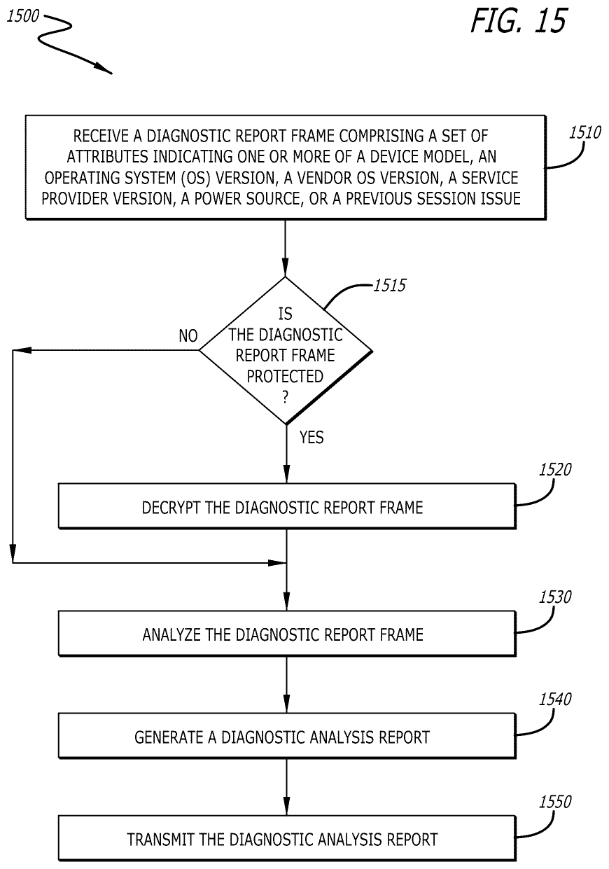

Referring to FIG. 15, a flowchart depicting a process 1500 for decrypting a diagnostic report frame in accordance with various embodiments of the disclosure is shown. In further embodiments, the process 1500 may receive a diagnostic report frame including a set of attributes indicating one or more of a device model, an Operating System (OS) version, a vendor OS version, a service provider version, a power source, or a previous session issue (block 1510). In many further embodiments, the process 1500 may receive the diagnostic report frame from the wireless device. In various embodiments, the wireless device may proactively send the diagnostic report frame to the network device, regardless of whether a request has been made by the network device. The wireless device can transmit the diagnostic report frame immediately after establishing a connection with the network device. This capability may facilitate real-time communication and improves the efficiency of data reporting, ensuring that the network device receives essential updates or status information without any delay.

In examples, based on the subelement field corresponding to the device model, an attribute of the set of attributes may include a model identifier of the wireless device. In further examples, based on the subelement field corresponding to the OS version, an attribute of the set of attributes may include a version identifier of a primary OS of the wireless device. In further additional examples, based on the subelement field corresponding to the vendor OS version, an attribute of the set of attributes may include a version identifier of a vendor-specific OS of the wireless device. In many examples, based on the subelement field corresponding to the service provider version, an attribute of the set of attributes may include an identifier for a service provider software version of the wireless device. In many more examples, based on the subelement field corresponding to the power source, an attribute of the set of attributes may include an indication for a source of power of the wireless device. In numerous examples, based on the subelement field corresponding to the previous session issue, an attribute of the set of attributes may include one or more of a failure epoch timestamp, a BSSID, a signal characteristic indicator corresponding to a peer device, or a reason associated with an issue encountered in a previous wireless session of the wireless device. The signal characteristic indicator may be indicative of one or more of a signal strength or a signal quality. Examples of the signal characteristic indicator include, but are not limited to, an RSSI, an RCPI, an RSNI, an SNR, an SINR, and an SIR.

In several more embodiments, the process 1500 may determine whether the diagnostic report frame is protected (block 1515). In yet more embodiments, if the diagnostic report frame is encrypted, the process 1500 may determine the diagnostic report frame is protected. Upon determining that the diagnostic report frame is protected, the process 1500 may decrypt the diagnostic report frame (block 1520). In still various embodiments, the process 1500 may utilize one or more known decryption algorithms, for example, symmetric key decryption algorithm, asymmetric key decryption algorithm, HASH-based decryption algorithm, or the like, to decrypt the diagnostic report frame.

In several additional embodiments, if the diagnostic report frame is not encrypted or the diagnostic report frame is successfully decrypted, the process 1500 may analyze the diagnostic report frame (block 1530). In further embodiments, the process 1500 may analyze the one or more subelement fields of the diagnostic report frame to identify potential issues, failures, or areas for improvement associated with the wireless device. In examples, the one or more subelement fields may include detailed information related to the wireless devices, such as the device model, the OS version, the vendor OS version, the service provider version, the power source, and/or the previous session issue. By analyzing the one or more subelements, the process 1500 may identify potential issues that could impact functionality of the wireless device.

In numerous embodiments, the process 1500 may generate a diagnostic analysis report (block 1540). In a number of embodiments, the process 1500 may generate the diagnostic analysis report based on analyzing the diagnostic report frame received from the wireless device. In examples, the diagnostic analysis report may include one or more of a device status information, one or more network performance metrics, or one or more system logs associated with the wireless device. For example, the diagnostic analysis report may include information pertaining to the wireless device such as battery health, failed software updates, signal strength, a percentage of data packets lost during transmission, etc.

In still various embodiments, the process 1500 may transmit the diagnostic analysis report (block 1550). In several embodiments, the process 1500 may transmit the diagnostic analysis report to the wireless device. In more embodiments, the process 1500 may transmit the diagnostic analysis report to transmit the diagnostic analysis report to a central management server, a network administrator, or a monitoring system. In more embodiments, the transmitting of the diagnostic analysis report may be optional.

Although a specific embodiment for decrypting a diagnostic report frame suitable for carrying out the various steps, processes, methods, and operations described herein is discussed with respect to FIG. 15, any of a variety of systems and/or processes may be utilized in accordance with embodiments of the disclosure. For example, the process 1500 may receive the diagnostic report frame via an MLME interface. The elements depicted in FIG. 15 may also be interchangeable with other elements of FIGS. 1-14 and FIGS. 16-18 as required to realize a particularly desired embodiment.

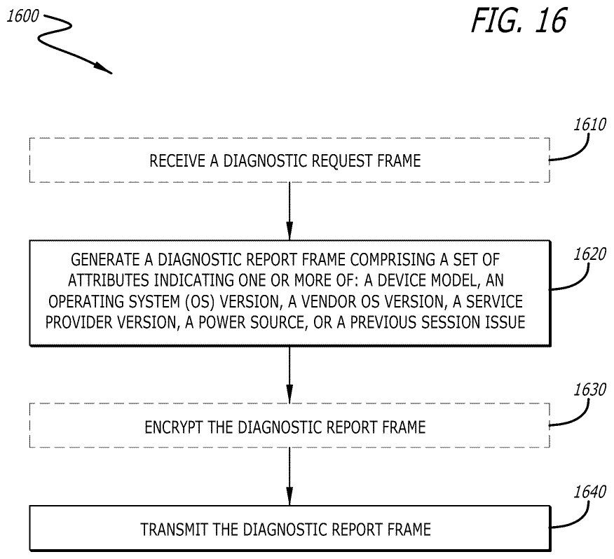

Referring to FIG. 16, a flowchart depicting a process 1600 for transmitting a diagnostic report frame to a network device in accordance with various embodiments of the disclosure is shown. In further embodiments, the process 1600 may receive a diagnostic request frame (block 1610). In many further embodiments, the process 1600 may receive the diagnostic request frame from a network device (for example, an access point). The diagnostic request frame may include one or more subelement fields corresponding to at least one of a device model, an Operating System (OS) version, a vendor OS version, a service provider version, a power source, or a previous session issue. In many examples, the diagnostic request frame may correspond to a wireless frame. The wireless frame may correspond to an association response frame or a reassociation response frame. In additional embodiments, receiving the diagnostic request frame may be optional.

In several embodiments, the process 1600 may generate a diagnostic report frame including a set of attributes indicating one or more of the device model, the OS version, the vendor OS version, the service provider version, the power source, or the previous session issue (block 1620). In various embodiments, the process 1600 may proactively generate the diagnostic report frame, for example, without receiving the diagnostic report frame from the network device. In examples, based on the subelement field corresponding to the device model, an attribute of the set of attributes may include a model identifier of the wireless device. In further examples, based on the subelement field corresponding to the OS version, an attribute of the set of attributes may include a version identifier of a primary OS of the wireless device. In further additional examples, based on the subelement field corresponding to the vendor OS version, an attribute of the set of attributes may include a version identifier of a vendor-specific OS of the wireless device. In many examples, based on the subelement field corresponding to the service provider version, an attribute of the set of attributes may include an identifier for a service provider software version of the wireless device. In many more examples, based on the subelement field corresponding to the power source, an attribute of the set of attributes may include an indication for a source of power of the wireless device. In numerous examples, based on the subelement field corresponding to the previous session issue, an attribute of the set of attributes may include one or more of a failure epoch timestamp, a BSSID, a signal characteristic indicator corresponding to a peer device, or a reason associated with an issue encountered in a previous wireless session of the wireless device. The signal characteristic indicator may be indicative of one or more of a signal strength or a signal quality. Examples of the signal characteristic indicator include, but are not limited to, an RSSI, an RCPI, an RSNI, an SNR, an SINR, and an SIR.

In various embodiments, the process 1600 may encrypt the diagnostic report frame (block 1630). Encrypting the diagnostic report frame before transmitting may ensure that only the intended network device can access the diagnostic report frame. In a number of embodiments, the process 1600 may utilize one or more known encryption algorithms, for example, symmetric key encryption algorithm, asymmetric key encryption algorithm, HASH- based encryption algorithm, or the like, to encrypt the diagnostic report frame. In many embodiments, the encryption of the diagnostic report frame may be optional.

In still more embodiments, the process 1600 may transmit the diagnostic report frame (block 1640). In some more embodiments, the process 1600 may transmit the diagnostic report frame to the network device as an option. In several embodiments, the network device may perform a diagnostic operation based on analyzing the diagnostic report frame. For example, the network device may analyze the diagnostic report frame to identify issues, such as network connectivity problems, device malfunctions, or performance degradation, and take appropriate actions for resolution (for example, initiating repairs, adjusting configurations, or sending updates to the wireless device).

Although a specific embodiment for transmitting a diagnostic report frame suitable for carrying out the various steps, processes, methods, and operations described herein is discussed with respect to FIG. 16, any of a variety of systems and/or processes may be utilized in accordance with embodiments of the disclosure. For example, the process 1600 may generate a diagnostic analysis report based on analyzing the diagnostic report frame. The elements depicted in FIG. 16 may also be interchangeable with other elements of FIGS. 1-15 and FIGS. 17-18 as required to realize a particularly desired embodiment.

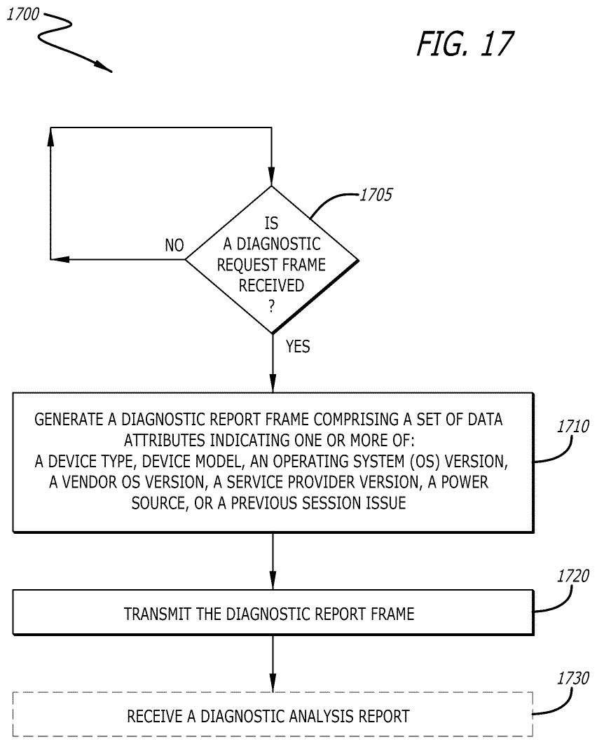

Referring to FIG. 17, a flowchart depicting a process 1700 for receiving a diagnostic analysis report from a network device in accordance with various embodiments of the disclosure is shown. In further embodiments, the process 1700 may determine whether a diagnostic request frame has been received (block 1705). In many further embodiments, the process 1700 may determine whether the diagnostic request frame has been received from a network device (for example, an access point). In response to determining that that the diagnostic request frame has not been received, the process 1700 may continue to determine whether the diagnostic request frame has been received (block 1705).

In several more embodiments, in response to determining that the diagnostic request frame has been received, the process 1700 may generate a diagnostic report frame including a set of attributes indicating one or more of a device type, a device model, an Operating System (OS) version, a vendor OS version, a service provider version, a power source, or a previous session issue (block 1710). In examples, the diagnostic request frame may include one or more subelement fields corresponding to at least one of the device type, the device model, the OS version, the vendor OS version, the service provider version, the power source, or the previous session issue. In various embodiments, the process 1700 may proactively generate the diagnostic report frame, for example, without receiving the diagnostic report frame from the network device. In examples, based on the subelement field corresponding to the device type, an attribute of the set of attributes may classify the wireless device as one of a tablet, a static sensor, a mobile sensor, a static emergency device, a mobile emergency device, an AR/VR device, a smartwatch, a smart wearable, a smart appliance, or a smart assistant. In many examples, based on the subelement field corresponding to the device model, an attribute of the set of attributes may include a model identifier of the wireless device. In further examples, based on the subelement field corresponding to the OS version, an attribute of the set of attributes may include a version identifier of a primary OS of the wireless device. In further additional examples, based on the subelement field corresponding to the vendor OS version, an attribute of the set of attributes may include a version identifier of a vendor-specific OS of the wireless device. In many examples, based on the subelement field corresponding to the service provider version, an attribute of the set of attributes may include an identifier for a service provider software version of the wireless device. In many more examples, based on the subelement field corresponding to the power source, an attribute of the set of attributes may include an indication for a source of power of the wireless device. In numerous examples, based on the subelement field corresponding to the previous session issue, an attribute of the set of attributes may include one or more of a failure epoch timestamp, a BSSID, a signal characteristic indicator corresponding to a peer device, or a reason associated with an issue encountered in a previous wireless session of the wireless device. The signal characteristic indicator may be indicative of one or more of a signal strength or a signal quality. Examples of the signal characteristic indicator include, but are not limited to, an RSSI, an RCPI, an RSNI, an SNR, an SINR, and an SIR.

In numerous embodiments, the process 1700 may transmit the diagnostic report frame (block 1720). In a number of embodiments, the process 1700 may transmit the diagnostic report frame to the network device. In many embodiments, the network device may perform a diagnostic operation based on analyzing the diagnostic report frame. For example, the network device may analyze the diagnostic report frame to identify issues, such as network connectivity problems, device malfunctions, or performance degradation, and take appropriate actions for resolution (for example, initiating repairs, adjusting configurations, or sending updates to the wireless device).

In yet various embodiments, the process 1700 may receive a diagnostic analysis report (block 1730). In several embodiments, the process 1700 may receive the diagnostic analysis report from the network device. In examples, the diagnostic analysis report may include one or more of a device status information, one or more network performance metrics, or one or more system logs associated with the wireless device. For example, the diagnostic analysis report may include information pertaining to the wireless device such as battery health, failed software updates, signal strength, a percentage of data packets lost during transmission, etc. In yet more embodiments, receiving of the diagnostic analysis report may be optional.

Although a specific embodiment for receiving the diagnostic report suitable for carrying out the various steps, processes, methods, and operations described herein is discussed with respect to FIG. 17, any of a variety of systems and/or processes may be utilized in accordance with embodiments of the disclosure. For example, the process 1700 may encrypt the diagnostic report frame before transmitting to the network device. The elements depicted in FIG. 17 may also be interchangeable with other elements of FIGS. 1-16 and FIG. 18 as required to realize a particularly desired embodiment.

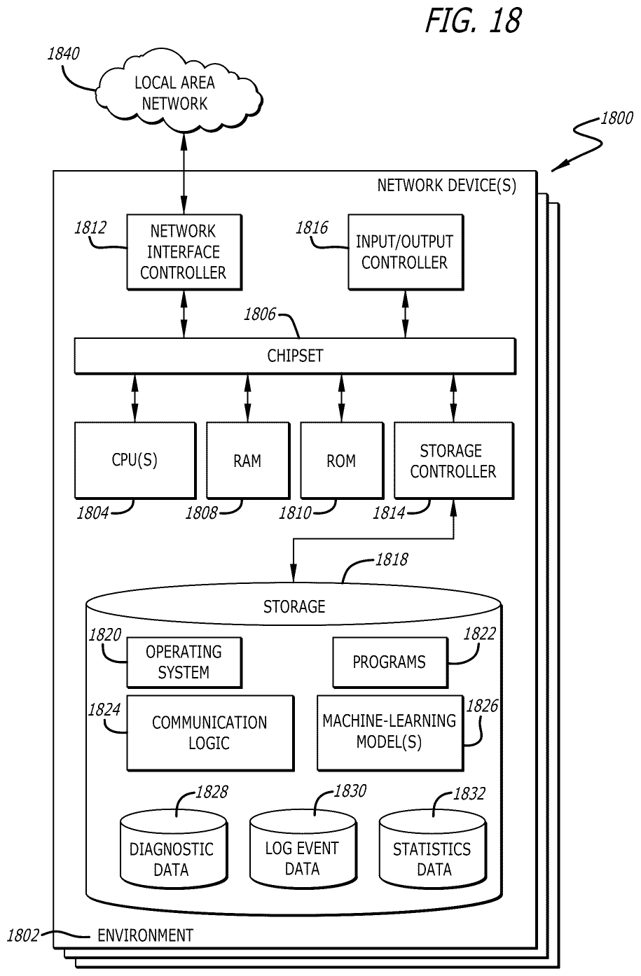

Referring to FIG. 18, a conceptual block diagram of a device 1800 suitable for configuration with a communication logic 1824 in accordance with various embodiments of the disclosure is shown. The embodiment of the conceptual block diagram depicted in FIG. 18 can illustrate a conventional server, switch, wireless LAN controller, access point, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 18 can also illustrate an access point, a switch, or a router in accordance with various embodiments of the disclosure. The device 1800 may, in many non-limiting examples, correspond to physical devices or virtual resources described herein.

In many embodiments, the device 1800 may include an environment 1802 such as a baseboard or “motherboard,” in physical embodiments that can be configured as a printed circuit board with a multitude of components or devices connected by way of a system bus or other electrical communication paths. Conceptually, in virtualized embodiments, the environment 1802 may be a virtual environment that encompasses and executes the remaining components and resources of the device 1800. In more embodiments, one or more processors 1804, such as, but not limited to, central processing units (“CPUs”) can be configured to operate in conjunction with a chipset 1806. The processor(s) 1804 can be standard programmable CPUs that perform arithmetic and logical operations necessary for the operation of the device 1800.

In a number of embodiments, the processor(s) 1804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders- subtractors, arithmetic logic units, floating-point units, and the like.

In various embodiments, the chipset 1806 may provide an interface between the processor(s) 1804 and the remainder of the components and devices within the environment 1802. The chipset 1806 can provide an interface to a random-access memory (“RAM”) 1808, which can be used as the main memory in the device 1800 in some embodiments. The chipset 1806 can further be configured to provide an interface to a computer-readable storage medium such as a read-only memory (“ROM”) 1810 or non-volatile RAM (“NVRAM”) for storing basic routines that can help with various tasks such as, but not limited to, starting up the device 1800 and/or transferring information between the various components and devices. The ROM 1810 or NVRAM can also store other application components necessary for the operation of the device 1800 in accordance with various embodiments described herein.

Additional embodiments of the device 1800 can be configured to operate in a networked environment using logical connections to remote computing devices and computer systems through a network, such as the network 1840. The chipset 1806 can include functionality for providing network connectivity through a network interface card (“NIC”) 1812, which may comprise a gigabit Ethernet adapter or similar component. The NIC 1812 can be capable of connecting the device 1800 to other devices over the network 1840. It is contemplated that multiple NICs 1812 may be present in the device 1800, connecting the device to other types of networks and remote systems.

In further embodiments, the device 1800 can be connected to a storage 1818 that provides non-volatile storage for data accessible by the device 1800. The storage 1818 can, for instance, store an operating system 1820 and programs 1822 (e.g., applications). The storage 1818 can be connected to the environment 1802 through a storage controller 1814 connected to the chipset 1806. In certain embodiments, the storage 1818 can consist of one or more physical storage units. The storage controller 1814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1800 can store data within the storage 1818 by transforming the physical state of the physical storage units to reflect the information being stored. The specific transformation of physical state can depend on various factors. Examples of such factors can include, but are not limited to, the technology used to implement the physical storage units, whether the storage 1818 is characterized as primary or secondary storage, and the like.

In many more embodiments, the device 1800 can store information within the storage 1818 by issuing instructions through the storage controller 1814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1800 can further read or access information from the storage 1818 by detecting the physical states or characteristics of one or more particular locations within the physical storage units.

In addition to the storage 1818 described above, the device 1800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1800. In some examples, the operations performed by a cloud computing network, and or any components included therein, may be supported by one or more devices similar to device 1800. Stated otherwise, some or all of the operations performed by the cloud computing network, and or any components included therein, may be performed by one or more devices 1800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1818 can store an operating system 1820 utilized to control the operation of the device 1800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1818 can store other system or application programs and data utilized by the device 1800.

In many additional embodiments, the storage 1818 or other computer-readable storage media is encoded with computer-executable instructions which, when loaded into the device 1800, may transform it from a general-purpose computing system into a special-purpose computer capable of implementing the embodiments described herein. These computer-executable instructions may be stored as programs 1822 (e.g., an application) and transform the device 1800 by specifying how the processor(s) 1804 can transition between states, as described above. In some embodiments, the device 1800 has access to computer-readable storage media storing computer-executable instructions which, when executed by the device 1800, perform the various processes described above with regard to FIGS. 1-18. In certain embodiments, the device 1800 can also include computer-readable storage media having instructions stored thereupon for performing any of the other computer-implemented operations described herein.

In many further embodiments, the device 1800 may include the communication logic 1824. The communication logic 1824 can be configured to perform one or more of the various steps, processes, operations, and/or other methods that are described above. Often, the communication logic 1824 can be a set of instructions stored within a non-volatile memory that, when executed by the processor(s) 1804 can carry out these steps, etc. In some embodiments, the communication logic 1824 may be a client application that resides on a network-connected device, such as, but not limited to, a server, switch, personal or mobile computing device in a single or distributed arrangement.

In a scenario where the device 1800 is a network device, the communication logic 1824 may be configured to generate a diagnostic request frame comprising one or more subelement fields corresponding to at least one of: a device type, device model, an Operating System (OS) version, a vendor OS version, a service provider version, a power source, or a previous session issue. The communication logic 1824 may transmit the diagnostic request frame to a wireless device. The communication logic 1824 may further receive, from the wireless device, in response to the diagnostic request frame, a diagnostic report frame comprising a set of attributes associated with the one or more subelement fields.

In a scenario where the device 1800 is a wireless device, the communication logic 1824 may be configured to generate a diagnostic report frame a set of attributes indicating one or more of: a device model, an OS version, a vendor OS version, a service provider version, a power source, or a previous session issue associated with the device 1800. The communication logic 1824 may transmit the diagnostic report frame to a network device.

In some embodiments, the storage 1818 can include diagnostic data 1828. The diagnostic data 1828 can encompass a set of attributes indicating one or more of a device model, an OS version, a vendor OS version, a service provider version, a power source, or a previous session issue indicated by a wireless device in a diagnostic report frame to the device 1800. For example, the diagnostic data 1828 may include a model identifier of the wireless device, a version identifier of a primary OS of the wireless device, a version identifier of a vendor-specific OS of the wireless device, an identifier for a service provider software version of the wireless device, an indication for a source of power of the wireless device, one or more of a failure epoch timestamp, a BSSID, a signal characteristic indicator corresponding to a peer device, or a reason associated with an issue encountered in a previous wireless session of the wireless device. The signal characteristic indicator may be indicative of one or more of a signal strength or a signal quality. Examples of the signal characteristic indicator include, but are not limited to, an RSSI, an RCPI, an RSNI, an SNR, an SINR, and an SIR. In various embodiments, the communication logic 1824 may perform a diagnostic operation for the wireless device utilizing the diagnostic data 1828.

In various embodiments, the storage 1818 can include log event data 1830. The log event data 1830 may include information about events associated with the wireless device. For example, the log event data 1830 may include information about the last roaming event, such as a timestamp associated with the roaming event, a reason for the roaming event, and network conditions during the roaming event. The log event data 1830 may further include information about an event when the wireless device was last disconnected from the network, such as a timestamp associated with the disconnection, a reason for disconnection, or a status of the wireless device at the time of disconnection. Furthermore, the log event data 1830 may further include information related to a set of events performed by the network device, such as event type, timestamp for each event, etc. In many embodiments, the network device may utilize the log event data 1830 to assess the behavior and performance of the wireless devices. In an example, the log event data 1830 can be obtained based on a WNM log request frame and a WNM log report frame related exchange between the network device and the wireless device.

In a number of embodiments, the storage 1818 can include statistics data 1832. The statistics data 1832 may include statistics-related data associated with a wireless device. For example, the statistics data 1832 may include Quality of Service (QoS) related statistics data, group identity and statistics data, signal quality and throughput metrics, or the like. In an example, the statistics data 1832 can be obtained based on a statistics report request frame and a statistics report frame related exchange between the network device and the wireless device.

In still further embodiments, the device 1800 can also include one or more input/output controllers 1816 for receiving and processing input from a number of input devices, such as a keyboard, a mouse, a touchpad, a touch screen, an electronic stylus, or other type of input device. Similarly, an input/output controller 1816 can be configured to provide output to a display, such as a computer monitor, a flat panel display, a digital projector, a printer, or other type of output device. Those skilled in the art will recognize that the device 1800 might not include all of the components shown in FIG. 18 and can include other components that are not explicitly shown in FIG. 18 or might utilize an architecture completely different than that shown in FIG. 18.

As described above, the device 1800 may support a virtualization layer, such as one or more virtual resources executing on the device 1800. In some examples, the virtualization layer may be supported by a hypervisor that provides one or more virtual machines running on the device 1800 to perform functions described herein. The virtualization layer may generally support a virtual resource that performs at least a portion of the techniques described herein.

In numerous additional embodiments, data may be processed into a format usable by a machine-learning (“ML”) model 1826 (e.g., feature vectors), and or other pre-processing techniques. The ML model 1826 may be any type of ML model, such as supervised models, reinforcement models, and/or unsupervised models. The ML model 1826 may include one or more of linear regression models, logistic regression models, decision trees, Naïve Bayes models, neural networks, k-means cluster models, random forest models, and/or other types of ML models. The ML model 1826 may be configured to analyze the diagnostic data 1828, the log event data 1830, and the statistics data 1832 for augmented information exchange between a network device and a wireless device. In further additional embodiments, the ML model 1826 may be utilized to identify various parameters to include in the diagnostic data 1828, the log event data 1830, and the statistics data 1832. For example, the ML model 1826 may analyze the diagnostic data 1828, the log event data 1830, and the statistics data 1832 and identify parameters that are required to augment the diagnostic data 1828, the log event data 1830, and the statistics data 1832. Once the parameters are identified, the communication logic 1824 may utilize the parameters to perform augmented information exchange between the network device and the wireless device. For example, the ML model 1826 may be configured to receive the diagnostic data 1828, the log event data 1830, and the statistics data 1832. The communication logic 1824 may then utilize trained models to perform augmented information exchange between the network device and the wireless device in a wireless network.

Although a specific embodiment for a device suitable for configuration with the networking logic for carrying out the various steps, processes, methods, and operations described herein is discussed with respect to FIG. 18, any of a variety of systems and/or processes may be utilized in accordance with embodiments of the disclosure. For example, the device 1800 may be in a virtual environment such as a cloud-based network administration suite, or it may be distributed across a variety of network devices or APs. The elements depicted in FIG. 18 may also be interchangeable with other elements of FIGS. 1-18 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
one or more processors; and
a memory communicatively coupled to the one or more processors, wherein the memory comprises a communication logic that is configured to:
generate a diagnostic request frame comprising one or more subelement fields corresponding to at least one of: a device model, an Operating System (OS) version, a vendor OS version, a service provider version, a power source, or a previous session issue;
transmit the diagnostic request frame to a wireless device; and
receive, from the wireless device, in response to the diagnostic request frame, a diagnostic report frame comprising a set of attributes associated with the one or more subelement fields.

2. The network device of claim 1, wherein the network device comprises an access point.

3. The network device of claim 1, wherein the wireless device comprises a station.

4. The network device of claim 1, wherein, based on the one or more subelement fields corresponding to the device model, an attribute of the set of attributes comprises a model identifier of the wireless device.

5. The network device of claim 1, wherein, based on the one or more subelement fields corresponding to the OS version, an attribute of the set of attributes comprises a version identifier of a primary OS of the wireless device.

6. The network device of claim 1, wherein, based on the one or more subelement fields corresponding to the vendor OS version, an attribute of the set of attributes comprises a version identifier of a vendor-specific OS of the wireless device.

7. The network device of claim 1, wherein, based on the one or more subelement fields corresponding to the service provider version, an attribute of the set of attributes comprises an identifier for a service provider software version of the wireless device.

8. The network device of claim 1, wherein, based on the one or more subelement fields corresponding to the power source, an attribute of the set of attributes comprises an indication for a source of power of the wireless device.

9. The network device of claim 1, wherein, based on the one or more subelement fields corresponding to the previous session issue, an attribute of the set of attributes comprises one or more of: a failure epoch timestamp, a Basic Service Set Identifier (BSSID), a signal characteristic indicator corresponding to a peer device, or a reason associated with an issue encountered in a previous wireless session of the wireless device.

10. The network device of claim 1, wherein the communication logic is further configured to receive the diagnostic report frame via a Medium Access Control Layer Management Entity (MLME) interface.

11. The network device of claim 1, wherein the one or more subelement fields further correspond to a device type.

12. The network device of claim 11, wherein, based on the one or more subelement fields further corresponding to the device type, an attribute of the set of attributes classifies the wireless device as one of: a tablet, a static sensor, a mobile sensor, a static emergency device, a mobile emergency device, an Augmented Reality/Virtual Reality (AR/VR) device, a smartwatch, a smart wearable, a smart appliance, or a smart assistant.

13. The network device of claim 1, wherein the communication logic is further configured to:
analyze the received diagnostic report frame;
generate a diagnostic analysis report based on the analysis; and
transmit the diagnostic analysis report to the wireless device.

14. The network device of claim 13, wherein the diagnostic analysis report comprises one or more of: a device status information, one or more network performance metrics, or one or more system logs associated with the wireless device.

15. The network device of claim 1, wherein the diagnostic request frame corresponds to a wireless frame.

16. The network device of claim 15, wherein the wireless frame corresponds to one of an association response frame or a re-association response frame.

17. A wireless device, comprising:
one or more processors; and
a memory communicatively coupled to the one or more processors, wherein the memory comprises a communication logic that is configured to:
generate a diagnostic report frame comprising a set of attributes indicating one or more of: a device model, an Operating System (OS) version, a vendor OS version, a service provider version, a power source, or a previous session issue associated with the wireless device; and
transmit the diagnostic report frame to a network device.

18. The wireless device of claim 17, wherein the diagnostic report frame corresponds to one of a protected wireless frame or an unprotected wireless frame.

19. The wireless device of claim 17, wherein the diagnostic report frame corresponds to one of a solicited response frame or an unsolicited response frame.

20. A method, comprising:
generating a diagnostic request frame comprising one or more subelement fields corresponding to at least one of: a device model, an Operating System (OS) version, a vendor OS version, a service provider version, a power source, or a previous session issue;
transmitting the diagnostic request frame to a wireless device; and
receiving, from the wireless device, in response to the diagnostic request frame, a diagnostic report frame comprising a set of attributes associated with the one or more subelement fields.
